(19) United States
(12) Patent Application Publication
(10) Pub. No.: US 2026/0105538 A1
(43) Pub. Date: Apr. 16, 2026

(54) METHOD FOR LARGE-SCALE PREDICTION ON WATER REQUIREMENT OF CROP BASED ON SPATIOTEMPORAL FUSION MODEL UNDER PHYSICAL CONSTRAINT

(71) Applicants: Intelligent Equipment Research Center, Beijing Academy of Agriculture and Forestry Sciences, Beijing (CN); Information Technology Research Center, Beijing Academy of Agriculture and Forestry Sciences, Beijing (CN)

(72) Inventors: Zhonglili ZHANG, Beijing (CN); Liping CHEN, Beijing (CN); Zongren WANG, Beijing (CN); Wengang ZHENG, Beijing (CN); Jing YANG, Beijing (CN); Yibo WEI, Beijing (CN)

(73) Assignees: Intelligent Equipment Research Center, Beijing Academy of Agriculture and Forestry Sciences, Beijing (CN); Information Technology Research Center, Beijing Academy of Agriculture and Forestry Sciences, Beijing (CN)

(21) Appl. No.: 19/325,558

(22) Filed: Sep. 11, 2025

(30) Foreign Application Priority Data
Oct. 14, 2024 (CN) 202411429222.5

(51) Int. Cl. G06Q 50/02; G06N 3/045; G06N 3/084

(52) U.S. Cl. CPC G06Q 50/02; G06N 3/045; G06N 3/084

(57) ABSTRACT

A method for large-scale prediction on water requirement of crop based on a spatiotemporal fusion model under a physical constraint, is applied to the field of prediction of water requirement of crop, wherein the method includes: acquiring multi-source data at the starting time and multi-source data for at least one sampling interval; encoding and fusing the multi-source data at the starting time and the multi-source data for at least one sampling interval by 1DCNN-MLP to obtain a comprehensive feature expression; and inputting the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model.

### CROSS-REFERENCE TO THE RELATED APPLICATIONS

This application is based upon and claims priority to Chinese Patent Application No. 202411429222.5, filed on Oct. 14, 2024, the entire contents of which are incorporated herein by reference.

### TECHNICAL FIELD

The present disclosure relates to the technical field of prediction on water requirement of crop, and in particular to a method for large-scale prediction on water requirement of crop based on a spatiotemporal fusion model under a physical constraint.

### BACKGROUND

Prediction on water requirement of crop is an important research direction in the agricultural field which predicts the water requirement for crop growth through scientific methods, and is beneficial to arranging irrigation reasonably and improving the crop yield. With the increasingly significant change in global climate, the fluctuation of temperature and rainfall also increases, which has an impact on the water requirement for crop growth. Therefore, accurate prediction on water requirement of crop is very important for the sustainability and the stability of agricultural production.

Most of the methods for calculating the water requirement of crop in related technologies are based on empirical formula fitting, but the water requirement of crop is influenced by many factors, such as meteorology, soil, crop and irrigation. There are complex interactions and dynamic changes among the factors. However, it is difficult for the methods for predicting the water requirement of crop in related technologies to take into account various factors comprehensively, which leads to inaccurate prediction.

### SUMMARY

The present disclosure provides a method for a large-scale prediction on water requirement of crop based on a spatiotemporal fusion model under a physical constraint, which is used to solve the defect that the method for predicting the water requirement of crop in the prior art is inaccurate in prediction and improve the precision and the reliability of water requirement of crop prediction.

The present disclosure provides a method for large-scale prediction on water requirement of crop based on a spatiotemporal fusion model under a physical constraint, including the following steps: acquiring multi-source data at a starting time and multi-source data for at least one sampling interval, where the multi-source data includes meteorological data, soil data and crop data; encoding and fusing the multi-source data at the starting time and the multi-source data for at least one sampling interval by a one-dimensional convolution and a multilayer perceptron to obtain a comprehensive feature expression, where the comprehensive feature expression includes a meteorological feature at each time, a soil feature at each time and a crop feature at each time; and inputting the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

In the method for the large-scale prediction of water requirement of crop based on the spatiotemporal fusion model under the physical constraint according to the present disclosure, after acquiring multi-source data at the starting time and multi-source data for at least one sampling interval, the method further includes: inputting the multi-source data based on a tabular form, and performing time alignment on the multi-source data to obtain multi-source data with a unified format; removing abnormal values from meteorological data in the multi-source data with the unified format based on a sliding window box plot to obtain cleaned meteorological data; removing abnormal values from soil data in the multi-source data with the unified format based on a Mahalanobis distance to obtain cleaned soil data; removing abnormal values from crop data in the multi-source data with the unified format based on a preset value range to obtain cleaned crop data; setting the cleaned meteorological data, the cleaned soil data and the cleaned crop data as cleaned multi-source data; performing K-nearest neighbor interpolation for missing values of the cleaned multi-source data in spatial positions, and performing linear interpolation for missing values of the cleaned multi-source data in temporal positions to obtain filled multi-source data; and normalizing the filled multi-source data based on min-max normalization to obtain preprocessed multi-source data.

In the method for the large-scale prediction of water requirement of crop based on the spatiotemporal fusion model under the physical constraint according to the present disclosure, the encoding and fusing the multi-source data at the starting time and the multi-source data for at least one sampling interval by a one-dimensional convolution and a multilayer perceptron to obtain a comprehensive feature expression, includes: constructing a meteorological feature matrix based on meteorological features of the meteorological data, the starting time, the sampling interval and the number of sampling points, where the meteorological features include air temperature, humidity, atmospheric pressure, wind speed, precipitation and sunshine duration; performing one-dimensional convolution processing on the meteorological feature matrix to obtain an output feature map of meteorological feature data; constructing a soil feature matrix based on soil features of the soil data, the starting time, the sampling interval and the number of sampling points, where the soil features include daily mean soil temperatures at a plurality of depth positions, humidity at a plurality of depth positions and water contents at a plurality of depth positions; performing one-dimensional convolution processing on the soil feature matrix to obtain an output feature map of soil feature data; constructing a crop feature matrix based on crop features of the crop data, the starting time, the sampling interval and the number of sampling points, where the crop features include a type of a crop, a plant height of the crop, a root depth of the crop, a leaf area index of the crop and chlorophyll content of the crop; performing one-dimensional convolution processing on the crop feature matrix to obtain an output feature map of crop feature data; and inputting the output feature map of the meteorological feature data, the output feature map of the soil feature data and the output feature map of the crop feature data into a multilayer perceptron neural network to obtain the comprehensive feature expression output by the multilayer perceptron neural network.

In the method for the large-scale prediction of water requirement of crop based on the spatiotemporal fusion model under the physical constraint according to the present disclosure, the inputting the comprehensive feature expression into a trained spatiotemporal feature fusion model to obtain a prediction result of water requirement of crop at a target time output by the trained spatiotemporal feature fusion model, includes: determining a target node corresponding to the meteorological data at the target time, the soil data at the target time and the crop data at the target time in the comprehensive feature expression; performing weighted aggregation on features of neighborhood nodes of the target node through the graph convolution network model of the trained spatiotemporal feature fusion model to obtain spatial features of the target node; determining long time sequence of the comprehensive feature expression based on a self-attention mechanism through the Informer model of the trained spatiotemporal feature fusion model; and determining temporal features of the target node based on the long time sequence of the comprehensive feature expression; and determining the prediction result of water requirement of crop at the target time based on the spatial features of the target node and the temporal features of the target node through the trained spatiotemporal feature fusion model.

In the method for the large-scale prediction on water requirement of crop based on the spatiotemporal fusion model under the physical constraint according to the present disclosure, before inputting the comprehensive feature expression into the trained spatiotemporal feature fusion model to obtain the prediction result of water requirement of crop at the target time output by the trained spatiotemporal feature fusion model, the method further includes: acquiring multi-source data samples, and dividing the multi-source data samples into a training sample set and a test sample set according to a preset proportion; training a preset spatiotemporal feature fusion model based on the training sample set, and performing gradient update on the preset spatiotemporal feature fusion model based on an Adaptive Moment Estimation (Adam) optimizer to obtain a spatiotemporal feature fusion model after trained; and evaluating the spatiotemporal feature fusion model after trained based on a root mean squared error, a mean absolute deviation and a determination coefficient to obtain the trained spatiotemporal feature fusion model.

In the method for the large-scale prediction on water requirement of crop based on the spatiotemporal fusion model under the physical constraint according to the present disclosure, the method further includes: inputting the training sample set into a preset World Food Studies (WOFOST) physical model to obtain a simulated water requirement of crop output by the preset WOFOST physical model; inputting the training sample set into the preset spatiotemporal feature fusion model to obtain a predicted water requirement of crop output by the preset spatiotemporal feature fusion model; and determining a loss function of the preset spatiotemporal feature fusion model under a constraint of the WOFOST physical model based on an actual water requirement of crop in the training sample set, the simulated water requirement of crop and the predicted water requirement of crop.

The present disclosure further provides a device for large-scale prediction of water requirement of crop based on a spatiotemporal fusion model under a physical constraint, including following modules: an acquisition module, which is configured to acquire multi-source data at a starting time and multi-source data for at least one sampling interval, where the multi-source data includes meteorological data, soil data and crop data; a feature fusion module, which is configured to encode and fuse the multi-source data at the starting time and the multi-source data for the at least one sampling interval by a one-dimensional convolution and a multilayer perceptron to obtain a comprehensive feature expression, where the comprehensive feature expression includes a meteorological feature at each time, a soil feature at each time and a crop feature at each time; and a prediction module, which is configured to input the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

The present disclosure further provides an electronic device, including a memory, a processor and a computer program stored in the memory and executable on the processor, where the processor, when executing the computer program, achieves the method for the large-scale prediction on water requirement of crop based on the spatiotemporal fusion model under the physical constraint described above.

The present disclosure further provides a non-transitory computer-readable storage medium, on which a computer program is stored, where the computer program, when executed by a processor, achieves the method for the large-scale prediction on water requirement of crop based on the spatiotemporal fusion model under the physical constraint described above.

The present disclosure further provides a computer program product, including a computer program, where the computer program, when executed by a processor, achieves the method for the large-scale prediction on water requirement of crop based on the spatiotemporal fusion model under the physical constraint described above.

According to the method for the large-scale prediction on water requirement of crop based on the spatiotemporal fusion model under the physical constraint, meteorological data, soil data and crop data at the starting time and for a plurality of subsequent sampling intervals are acquired, thereby taking into full account various factors such as the type of the crop, soil characteristics and climate conditions. The multi-source data at the starting time and for a plurality of subsequent sampling intervals are encoded and fused by a one-dimensional convolution and a multilayer perceptron to obtain a comprehensive feature expression which is used to express meteorological features, soil features and crop features at each time, thereby exploring the relationship between features, combining original features into more meaningful high-level features, reducing the feature dimension, and improving the comprehensiveness of the feature expression. The comprehensive feature expression is input into a trained spatiotemporal feature fusion model, so as to extract spatial features through the graph convolution network model and extract temporal features through the Informer model to obtain a prediction result of water requirement of crop at the target time, thereby capturing the interaction between data of different stations and the time trend of historical data more effectively, and improving the generalization ability of the model in different areas and the prediction precision of the water requirement of crop, and thus addressing the technical problem that it is difficult for the methods for predicting the water requirement of crop in related technologies to take into account various factors comprehensively, resulting in inaccurate prediction.

### BRIEF DESCRIPTION OF THE DRAWINGS

In order to explain the technical scheme of the present disclosure or the prior art more clearly, the drawings needed to be used in the description of the embodiments or the prior art will be briefly introduced one by one. Obviously, the drawings in the following description are some embodiments of the present disclosure. Other drawings can be obtained according to these drawings without paying creative labor for those skilled in the art.

FIG. 1 is a flow chart of a method for large-scale prediction on water requirement of crop based on a spatiotemporal fusion model under a physical constraint according to the present disclosure.

FIG. 2 is an overall flow chart of a method for large-scale prediction on water requirement of crop based on a spatiotemporal fusion model under a physical constraint according to the present disclosure.

FIG. 3 is a schematic diagram of a technical idea of a method for large-scale prediction on water requirement of crop based on a spatiotemporal fusion model under a physical constraint according to the present disclosure.

FIG. 4 is a schematic structural diagram of a device for large-scale prediction on water requirement of crop based on a spatiotemporal fusion model under a physical constraint according to the present disclosure.

FIG. 5 is a schematic diagram of a physical structure of an electronic device according to the present disclosure.

### DETAILED DESCRIPTION OF THE EMBODIMENTS

In order to make the purpose, the technical scheme and the advantages of the present disclosure more clear, the technical scheme in the present disclosure will be described clearly and completely with reference to the attached drawings hereinafter. Obviously, the described embodiments are some of the embodiments of the present disclosure, rather than all of the embodiments. Based on the embodiments in the present disclosure, all other embodiments obtained by those skilled in the art without paying creative labor belong to the scope of protection of the present disclosure.

The prediction on water requirement of crop is an important research direction in the agricultural field which predicts the water requirement of crop growth through scientific methods, and is beneficial to arranging irrigation reasonably and improving the crop yield. With the increasingly significant change in global climate, the fluctuation of air temperature and precipitation also increases, which has an impact on the water requirement for crop growth. Therefore, accurate prediction on water requirement of crop is very important for the sustainability and the stability of agricultural production. Using the big data technology, the meteorology and the model algorithm, the water requirement of crop can be predicted according to various factors such as the type of the crop, soil characteristics and climatic conditions, so as to make scientific irrigation decisions, improve the farmland utilization rate, reduce water waste and achieve efficient and intelligent management of agricultural production.

Most of the traditional methods for calculating the water requirement of crop are based on empirical formula fitting, but the water requirement of crop is influenced by many factors such as meteorology, soil, crop and irrigation. There are complex interactions and dynamic changes among the factors. However, it is difficult for the traditional methods for calculating the water requirement of crop to take into account various factors comprehensively, which leads to inaccurate prediction. In addition, the current method for calculating the water requirement of crop mainly takes the station as the scale, which cannot effectively support large-scale or regional water management, and lacks sufficient interpretability. Therefore, there is an urgent need for a method for large-scale interpretable prediction on water requirement of crop in combination with spatio-temporal features to improve the precision and the reliability of the prediction on water requirement of crop.

There are mainly the following traditional methods for predicting the water requirement of crop.

Empirical formula method performs calculation and prediction by empirical formulas based on historical meteorological data and crop growth features. These formulas often rely on previous research or practical experience.

Statistical regression method analyzes the relationship between historical meteorological data and the water requirement of crop by establishing a statistical model, so as to make prediction. This method usually requires a large number of historical data for regression analysis, which is only effective under specific meteorological and agricultural conditions. These methods cannot be applied in the areas with different conditions.

Model method finds out the relationship between the water requirement of crop and external factors by establishing statistical analysis of historical data, and predicts the water requirement of crop by mathematical modeling. Although this method can take into account the influence of many factors, this method may rely too much on historical data and ignore the physical constraints and mechanisms behind the water requirement of crop, such as the type of soil, crop characteristics, topography and other factors. Ignoring these factors will still influence the accuracy of prediction results.

Therefore, in order to overcome the shortcomings in related technologies and improve the precision and the interpretability of prediction on the water requirement of crop in a large-scale range, the research of the present disclosure mainly focuses on the following three aspects.

Multi-source information coupling: the water requirement of crop is often influenced by many factors such as meteorology, soil and crops, but in the acquisition and analysis of agricultural production data, data are often missing, which may influence the feasibility of irrigation management and the accurate evaluation of key parameters such as the water requirement of crop. Through the multi-source data coupling technology, the information from different data sources can be cross-validated, supplemented and corrected to make up for the lack of a certain source data, improve the integrity and the accuracy of data, and provide a strong data support for subsequent model training.

Spatiotemporal model fusion: the traditional model for predicting the water requirement of crop is a data model usually based on a single station, which may lack generalization ability in different areas or at different times, resulting in limited predicting accuracy. Therefore, the present disclosure takes into account the factors such as the climatic environment, soil characteristics and crop growth conditions in different areas, and establishes a prediction model, that is, Graph Convolution Network (GCN)-Informer, which comprehensively takes into account the spatiotemporal variation. In the Graph Convolution Network (GCN), the graph convolution layer can capture the information propagation and interaction between different locations by convolution operation on the spatial adjacency matrix, and obtain the spatial information of different time segments. In the Informer, the Informer can efficiently process an extremely long input sequence through the self-attention distilling technology, effectively capture long-term dependence in spatial information in different time segments, and predict the whole long time sequence at one time, which greatly improves the efficiency in the prediction process. Through fusion of spatio-temporal features, the prediction precision and the large-scale prediction ability of the water requirement of crop are effectively improved.

Physical mechanism constraints: because the neural network models are usually data-driven, patterns and laws are learned through a large amount of data. If the data is insufficient or the data is poor in quality, the model may have over-fitting problems, resulting in unstable or inaccurate prediction results. In order to overcome the problem that the neural network model is excessively dependent on data, the present disclosure takes into account combining the physical mechanism knowledge with the neural network model to design a GCN-Informer model under the physical constraint of the WOFOST, and generates a more robust and effective model by embedding the WOFOST physical model into a loss function and constraining the model training, thus ensuring the accuracy and the reliability of prediction on water requirement of crop.

To sum up, the present disclosure provides a method for large-scale prediction on water requirement of crop based on a spatiotemporal fusion model under a physical mechanism constraint. This method integrates multi-source information such as meteorology, soil and crops, combines with the deep learning technology to construct a GCN-Informer model with spatiotemporal feature fusion, fully takes into account the physical location information of different areas and the temporal features of historical data, and through combining with the WOFOST physical model to constrain the neural network training, improves the precision and the practicability of prediction on water requirement of crop, which provides a powerful scientific basis and a technology support for irrigation management.

Optionally, the method for the large-scale prediction on water requirement of crop based on the spatiotemporal fusion model under the physical constraint according to the embodiment of the present disclosure can be executed by the server, the terminal device, or both the server and the terminal device. The method for the large-scale prediction on water requirement of crop based on the spatiotemporal fusion model under the physical constraint in this embodiment is executed by a server, which is taken as an example.

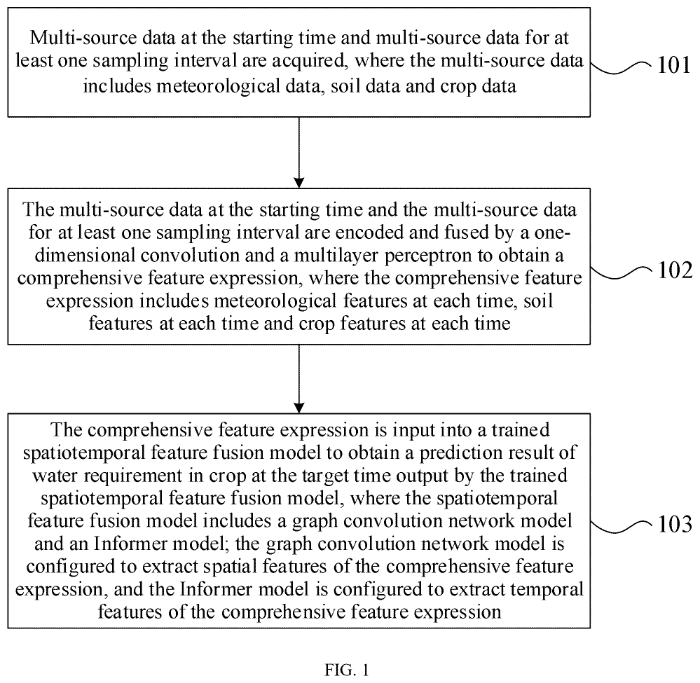

FIG. 1 is a flow diagram of a method for large-scale prediction on water requirement of crop based on a spatiotemporal fusion model under a physical constraint according to the present disclosure. As shown in FIG. 1, the method includes steps 101-103.

In step 101, multi-source data at the starting time and multi-source data for at least one sampling interval are acquired, where the multi-source data includes meteorological data, soil data and crop data.

At present, the method for calculating the water requirement of crop mainly takes the station as the scale, and only analyzes the relationship between historical meteorological data and the water requirement of crop, so as to make prediction. This method usually requires a large number of historical data for regression analysis, which is only effective under specific meteorological and agricultural conditions. These methods cannot be applied in the areas with different conditions.

In the embodiment of the present disclosure, meteorological, soil and crop data of a plurality of stations at a plurality of times are acquired and integrated, and a comprehensive database is established, so that the water requirement of crop can be predicted according to various factors such as the type of the crop, soil characteristics and climate conditions, and large-scale or regional water management can be effectively supported.

In the embodiment of the present disclosure, after acquiring multi-source data (meteorological data, soil data and crop data) of each station at each time, the noise and the abnormal values are removed by using the data cleaning technology, and the quality of the model training data is improved by processing means such as standardization and normalization.

For example, meteorological data such as daily mean temperature, relative humidity, atmospheric pressure, wind speed, precipitation and sunshine duration are acquired through meteorological stations in different areas or by using the remote sensing data of satellites, and a meteorological database is established. Soil physical and chemical properties at different depths, including soil properties such as a soil layer, soil temperature, soil moisture and soil water content, are acquired using soil profiles or soil samples, and a soil database is established. Through the crop planting situation and related literatures, the parameters such as a type of the crop, a plant height of the crop, a root depth of the crop, a leaf area index of the crop and chlorophyll content of the crop are acquired, and a crop database is established.

In the embodiment of the present disclosure, the meteorological data extracted for each station form an input table according to the time sampling interval, where the sampling interval of soil data and the sampling interval of crop data are the same as that of meteorological data, and the specific starting time and the sampling interval (for example, usually every day) can be determined according to the actual application scenario of prediction on water requirement of crop.

In step 102, the multi-source data at the starting time and the multi-source data for at least one sampling interval are encoded and fused by a one-dimensional convolution and a multilayer perceptron to obtain a comprehensive feature expression, where the comprehensive feature expression includes meteorological features at each time, soil features at each time and crop features at each time.

In the embodiment of the present disclosure, a multi-input structure is used, and meteorological data, soil data and crop data which are input separately are encoded and fused by the one-dimensional convolution and the multilayer perceptron, so as to meet the input of the following graph convolution while reserving the ability of the graph convolution to learn data spatial features.

For example, the meteorological data are input as a matrix of m*n, where m is the number of sampling points (for example, meteorological stations). One-dimensional convolution is used to encode the meteorological features, in which the convolution kernel has a size of n, and the output channel is 1. The meteorological features at each time are convolved to obtain the comprehensive feature expression of meteorological feature data.

The soil data and crop data have convolution processes similar to that of the above-mentioned meteorological data, which will not be described in detail in the present disclosure.

A Multilayer Perceptron (MLP) neural network is used to couple the comprehensive feature expression of the fused meteorological feature data (meteorological features), the comprehensive feature expression of the fused soil data (soil features) and the comprehensive feature expression of the fused crop data (crop features). The input layer consists of three neurons, representing the three input features of meteorology, soil and crops, respectively. The output consists of a neuron, representing the comprehensive feature expression of the three features after being coupled.

According to the embodiment of the present disclosure, multi-source information (meteorological data, soil data and crop data) is coupled through the one-dimensional convolution and the MLP algorithm. The mutual relationship between features can be automatically explored, the interaction and nonlinearity between features can be captured, the complexity of data can be better expressed, and the original features can be combined into more meaningful high-order features, thereby reducing feature dimension and reducing the complexity of model training.

In step 103, the comprehensive feature expression is input into a trained spatiotemporal feature fusion model to obtain a prediction result of water requirement of crop at the target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

The related technology mainly depends on the data of a certain area or station. Because of the similarity of the data of the same area or station, the trained model is often only applicable to a specific area. It is difficult for these models to cross area boundaries, which limits their application in different areas.

Second, most of the existing model methods are single models, lacking diversity and comprehensiveness. A single model may not perform well in dealing with complex data, and different model structures should have different learning abilities for data features. Therefore, it is necessary to use a model fusion method, which combines spatial information with comprehensive and diverse data sets, and fully learns different structure features of data, so as to better capture the changes and regularity between different areas and improve the precision and the large-scale prediction ability of the model.

In the embodiment of the present disclosure, in order to combine the spatial position information of different areas and the historical change law of each station data, the present disclosure constructs a spatiotemporal feature fusion model of the GCN-Informer, where the graph convolution network model performs weighted aggregation on the features of neighborhood nodes through the graph structure to extract spatial features. The Informer uses a self-attention mechanism to model the long-term dependence in temporal data and extract the important features hidden in temporal data.

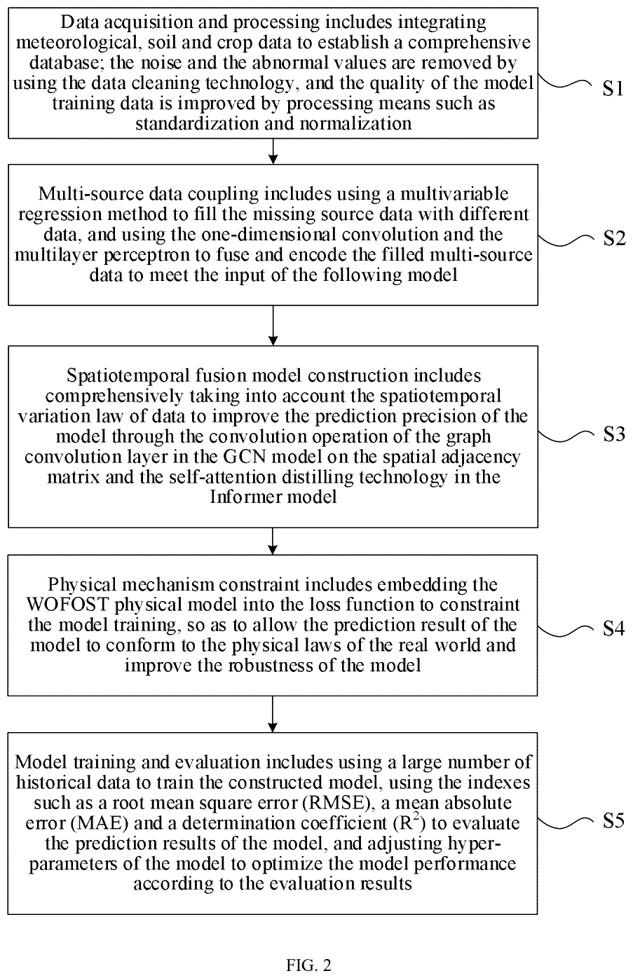

Referring to FIG. 2, FIG. 2 is an overall flow chart of a method for a large-scale prediction on water requirement of crop based on a spatiotemporal fusion model under a physical constraint according to the present disclosure, which specifically includes steps S1-S5.

In step S1, data acquisition and processing includes integrating meteorological, soil and crop data to establish a comprehensive database. The noise and the abnormal values are removed by using the data cleaning technology, and the quality of the model training data is improved by processing means such as standardization and normalization.

In step S2, multi-source data coupling includes using a multivariable regression method to fill the missing source data with different data, and using the one-dimensional convolution and the multilayer perceptron to fuse and encode the filled multi-source data to meet the input of the following model.

In step S3, spatiotemporal fusion model construction includes comprehensively taking into account the spatiotemporal variation law of data to improve the prediction precision of the model through the convolution operation of the graph convolution layer in the GCN model on the spatial adjacency matrix and the self-attention distilling technology in the Informer model.

In step S4, physical mechanism constraint includes embedding the WOFOST physical model into the loss function to constraint the model training, so as to allow the prediction result of the model to conform to the physical laws of the real world and improve the robustness of the model.

In step S5, model training and evaluation includes using a large number of historical data to train the constructed model, using the indexes such as a root mean square error (RMSE), a mean absolute error (MAE) and a determination coefficient (R²) to evaluate the prediction results of the model, and adjusting hyper-parameters of the model according to the evaluation results, to optimize the model performance.

The trained and optimized model is applied to the actual scene, and the current meteorological, soil and crop data are input to predict the water requirement of crop. According to the prediction results, a scientific basis and a decision support are provided for irrigation management in agricultural production, thereby achieving accurate irrigation, improving water resources utilization efficiency, and thus promoting agricultural sustainable development.

In order to overcome the defect of the existing method for predicting the water requirement of crop, the present disclosure provide a method for large-scale prediction on water requirement of crop based on a spatiotemporal fusion model under a physical mechanism constraint, so as to improve the precision and the practicability of prediction on water requirement of crop, and provide a powerful scientific basis and a technology support for irrigation management.

Specifically, the present disclosure aims to solve the following problems.

According to the present disclosure, the GCN-Informer spatiotemporal feature fusion model is established by a model fusion method, so that the effective combination of large-scale spatial features and temporal features is achieved, and the precision and the large-scale prediction ability of the model are improved.

According to the present disclosure, the WOFOST physical formula is introduced to establish a model training method under a physical constraint, which helps the model better understand and interpret data and significantly improves the precision and the reliability of prediction on water requirement of crop.

In the method for the large-scale prediction on water requirement of crop based on the spatiotemporal fusion model under the physical constraint according to the present disclosure, after acquiring multi-source data at the starting time and multi-source data for at least one sampling interval, the method further includes:
inputting the multi-source data based on a tabular form, and performing time alignment on the multi-source data to obtain multi-source data with a unified format;
removing abnormal values from the meteorological data in the multi-source data with the unified format based on a sliding window box plot to obtain cleaned meteorological data;
removing abnormal values from the soil data in the multi-source data with the unified format based on a Mahalanobis distance to obtain cleaned soil data;
removing abnormal values from the crop data in the multi-source data with the unified format based on a preset value range to obtain cleaned crop data;
setting the cleaned meteorological data, the cleaned soil data and the cleaned crop data as the cleaned multi-source data;
performing K-nearest neighbor interpolation for missing values of a spatial position of the cleaned multi-source data, and performing linear interpolation for missing values of a temporal position of the cleaned multi-source data to obtain the filled multi-source data; and
normalizing the filled multi-source data based on min-max normalization to obtain preprocessed multi-source data.

The water requirement of crop is often influenced by many factors such as meteorology, soil and crops, but in the acquisition and analysis of agricultural production data, data are often missing, which may influence the feasibility of the accurate evaluation and irrigation management of key parameters such as the water requirement of crop.

In the embodiment of the present disclosure, through the multi-source data coupling technology, the information of different data sources can be cross-validated, supplemented and corrected to make up for the lack of a certain source data, improve the integrity and the accuracy of data, and provide a strong data support for subsequent model training.

The present disclosure uses the following methods to acquire and process data of elements such as meteorology, soil and crops, including steps S1.1-1.4.

In step S1.1, the meteorological data is acquired. The meteorological data such as daily mean temperature, relative humidity, atmospheric pressure, wind speed, precipitation and sunshine duration are acquired by using data of meteorological stations in different areas or the remote sensing data of satellites, and a meteorological database is established.

In step S1.2, the soil data is acquired. Soil physical and chemical properties at different depths, including soil properties such as a soil layer, soil temperature, soil moisture and soil water content, are acquired using soil profiles or soil samples, and a soil database is established.

In step S1.3, the crop data is acquired. Through the crop planting situation and related literatures, the parameters such as a type of the crop, a plant height of the crop, a root depth of the crop, a leaf area index of the crop and chlorophyll content of the crop are acquired, and a crop database is established.

In step S1.4, the data is processed. The acquired meteorological, soil and crop data are cleaned, including operations such as checking whether the data format is uniform, identifying and deleting abnormal values and duplicate data, interpolation for missing values, and normalizing data to make the data meet the requirements of model input. The specific method includes steps S1.4.1-1.4.4.

In step S1.4.1, the data format is unified. The data are all input in a tabular form, time alignment is performed on the data with different time scales, and the data with more missing values are removed to ensure the uniform format of each type of data.

In step S1.4.2, the data is cleaned.

A sliding window box plot method is used to remove abnormal values from meteorological data. The quartiles Q₁ and Q₃ and the interquartile range IQR=Q₃−Q₁ of meteorological data in each time window are calculated. Any data point less than Q₁−1.5/QR or greater than Q₃+1.5/QR will be regarded as an abnormal value and deleted.

A Mahalanobis distance-based method is used to detect and remove abnormal values of soil data. For each soil parameter in each layer, the mean μ, the standard deviation σ, and the Mahalanobis distance MD=(x−μ)/σ are calculated, where x denotes a soil parameter, and then any data point with the Mahalanobis distance greater than 3 is regarded as an abnormal value and deleted.

An expert knowledge-based method used to detect and remove abnormal values of crop data. For each crop, the reasonable value range is determined according to related literatures or experience, and then the data points beyond this range are deleted.

In step S1.4.3, data interpolation is performed.

For the missing values in the spatial position, a K-nearest neighbor interpolation method is used. k samples with similar space in the data set are identified by distance measurement. Thereafter, these k samples are used to estimate the values of missing data points. The missing values of each sample are filled or interpolated using a weighted mean of the k neighborhood found in the dataset. The weight is the reciprocal of the distance. Refer to the following formula (1) for details:

$${\hat{x}}_{i} = \frac{{\sum }_{k = 1}^{K} {w}_{k} {x}_{k}}{{\sum }_{k = 1}^{K} {w}_{k}} \qquad ( 1 )$$

where îᵢ denotes a missing value of an i-th grid, xₖ denotes the data of a k-th nearest neighbor grid, wₖ=1/dₖ denotes a weight of the k-th nearest neighbor grid, dₖ denotes a distance between the k-th nearest neighbor grid and the i-th grid, and K denotes the total number of grids.

The missing value of the temporal position is filled by the linear interpolation based on the vertically adjacent upper and lower data. Refer to the following formula (2) for details:

$${\hat{x}}_{j} = \frac{{x}_{j - 1} + {x}_{j + 1}}{2} \qquad ( 2 )$$

where \hat{x}ⱼ denotes the missing value at the j-th time point, and xⱼ₋₁ and xⱼ₊₁ denote the data at the (j−1)-th and (j+1)-th time points, respectively.

For crop data, a common sense-based method is used to interpolate the data. If there are missing values in each crop parameters, the mean or median of the same or similar crop data in the same area or different areas is used to fill each crop parameters.

In step S1.4.4, the data is normalized. A min-max normalization method is used. For each type of data, the minimum value min and the maximum value max are found. For each data point xᵢ, the following formula (3) is used to normalize the data point to the interval of [0,1] to remove the dimension and scale difference of data:

$${\tilde{x}}_{{new}_{i}} = \frac{{x}_{i} - min}{max - min} \qquad ( 3 )$$

where \hat{x}_{new}_{ᵢ} denotes the normalized value, xᵢ denotes an i-th original value, and min and max denote the minimum value and the maximum value in all data, respectively.

According to the embodiment of the present disclosure, the database of preprocessed meteorological, soil, crop and other data can be obtained through the above data processing method to provide data support for subsequent simulation calculation.

In the method for the large-scale prediction on water requirement of crop based on the spatiotemporal fusion model under the physical constraint according to the present disclosure, the encoding and fusing the multi-source data at the starting time and the multi-source data for at least one sampling interval by a one-dimensional convolution and a multilayer perceptron to obtain a comprehensive feature expression, includes:
constructing a meteorological feature matrix based on the meteorological features of the meteorological data, the starting time, the sampling interval and the number of sampling points, where the meteorological features include air temperature, humidity, atmospheric pressure, wind speed, precipitation and sunshine duration;
performing one-dimensional convolution processing on the meteorological feature matrix to obtain an output feature map of meteorological feature data;
constructing a soil feature matrix based on the soil features of the soil data, the starting time, the sampling interval and the number of sampling points, where the soil features include daily mean soil temperatures of a plurality of depth positions, humidity of a plurality of depth positions and water contents of a plurality of depth positions;
performing one-dimensional convolution processing on the soil feature matrix to obtain an output feature map of soil feature data;
constructing a crop feature matrix based on the crop features of the crop data, the starting time, the sampling interval and the number of sampling points, where the crop features include a type of the crop, a plant height of the crop, a root depth of the crop, a leaf area index of the crop and chlorophyll content of the crop;
performing one-dimensional convolution processing on the crop feature matrix to obtain an output feature map of crop feature data; and
inputting the output feature map of the meteorological feature data, the output feature map of the soil feature data and the output feature map of the crop feature data into the multilayer perceptron neural network to obtain the comprehensive feature expression output by the multilayer perceptron neural network.

Most of the traditional methods for calculating the water requirement of crop are based on empirical formula fitting, but the water requirement of crop is influenced by many factors such as meteorology, soil, crop and irrigation. There are complex interactions and dynamic changes among the factors. However, it is difficult for the traditional methods for calculating the water requirement of crop to take into account various factors comprehensively, which leads to inaccurate prediction.

In the embodiment of the present disclosure, a multi-input structure is used, and meteorological data, soil data and crop data which are input separately are encoded and fused by the one-dimensional convolution and the multilayer perceptron, so as to meet the input of the following graph convolution while reserving the ability of the graph convolution to learn data spatial features, which specifically includes steps S2.1-2.4.

In step S2.1, meteorological data input is constructed. The meteorological data extracted for each station form an input table according to the time sampling interval, including data such as air temperature, humidity, atmospheric pressure, wind speed, precipitation, sunshine duration, etc., where the meteorological data input structure can refer to the following formula (4):

$$Q = [ \begin{matrix}{x}_{1 j} & {x}_{2 j} & … & {x}_{nj} \\ {x}_{1 j + d} & {x}_{2 j + d} & … & {x}_{nj + d} \\ {x}_{1 j + 2 d} & {x}_{2 j + 2 d} & … & {x}_{nj + 2 d} \\ ⋮ & ⋮ & ⋮ & ⋮ \\ {x}_{1 j + md} & {x}_{2 j + md} & … & {x}_{nj + md}\end{matrix} ] \qquad ( 4 )$$

where Q denotes meteorological data input, xₙ denotes the n-th meteorological feature (n is an index), j denotes the starting time point (starting time), d denotes the sampling interval (for example, every day), and m denotes the number of sampling points, so that the meteorological data input is a matrix of m*n. The meteorological features are fused by a one-dimensional convolution, in which the convolution kernel has a size of n, and the output channel is 1. The meteorological features at each time are convolved to obtain the comprehensive feature expression Qs of meteorological feature data. The output feature map of meteorological feature data can refer to the following formula (5):

$$Qs = [ \begin{matrix}{Q}_{j} \\ {Q}_{j + d} \\ {Q}_{j + 2 d} \\ ⋮ \\ {Q}_{j + md}\end{matrix} ] \qquad ( 5 )$$

where Qs denotes a comprehensive feature expression of meteorological feature data, Q denotes the meteorological data input, j denotes a starting time point (starting time), d denotes a sampling interval, and m denotes the number of sampling points.

In step S2.2, the soil data input is constructed. The data such as daily mean soil temperature, humidity and water content at four depth positions of 20 cm, 40 cm, 60 cm and 80 cm are recorded through a soil sensor, and are sampled according to the sampling interval which is the same as that of the meteorological data. The data structure of the soil data input can refer to the following formula (6):

$$T = [ \begin{matrix}{w}_{1 j} & {w}_{2 j} & … & {w}_{nj} \\ {w}_{1 j + d} & {w}_{2 j + d} & … & {w}_{nj + d} \\ {w}_{1 j + 2 d} & {w}_{2 j + 2 d} & … & {w}_{nj + 2 d} \\ ⋮ & ⋮ & ⋮ & ⋮ \\ {w}_{1 j + md} & {w}_{2 j + md} & … & {w}_{nj + md}\end{matrix} ] \qquad ( 6 )$$

where T denotes soil data input, wₙ denotes the n-th soil feature (n is an index), and the same feature data at different depths forms a column, j denotes a starting time point (starting time), d denotes a sampling interval (every day), and m denotes the number of sampling points, so that the soil data input forms also a matrix of m*n. A one-dimensional convolution is also used to fuse and encode features, in which the convolution kernel has a size of n, and the output channel is 1. The soil features at each time are convolved to obtain the comprehensive feature expression Ts of soil feature data. The output feature map of soil feature data can refer to the following formula (7):

$$T = [ \begin{matrix}{Q}_{j} \\ {Q}_{j + d} \\ {Q}_{j + 2 d} \\ ⋮ \\ {Q}_{j + md}\end{matrix} ] \qquad ( 7 )$$

where Ts denotes a comprehensive feature expression of soil feature data, T denotes the soil data input, j denotes a starting time point (starting time), d denotes a sampling interval (every day), and m denotes the number of sampling points.

In step S2.3, the crop data input is constructed. According to the crop planting situation, the parameters such as a type of the crop, a plant height of the crop, a root depth of the crop, a leaf area index of the crop and chlorophyll content of the crop are acquired, and the crop database is established. It is assumed that the number of types of the crops is C, and the data of each crop be a two-dimensional matrix. The crop data input structure can refer to the following formula (8):

$$Z = [ \begin{matrix}{z}_{1 j} & {z}_{2 j} & … & {z}_{nj} \\ {z}_{1 j + d} & {z}_{2 j + d} & … & {z}_{nj + d} \\ {z}_{1 j + 2 d} & {z}_{2 j + 2 d} & … & {z}_{nj + 2 d} \\ ⋮ & ⋮ & ⋮ & ⋮ \\ {z}_{1 j + md} & {z}_{2 j + md} & … & {z}_{nj + md}\end{matrix} ] \qquad ( 8 )$$

where Z denotes a crop data input, zₙ denotes the n-th crop data type (n is an index), j denotes a starting time point (starting time), d denotes a sampling interval (every day), and m denotes the number of sampling points. The crop data vector Zⱼ=(z₁, z₂, . . . , zₙ) at each sampling point is convolved by a one-dimensional convolution, in which the convolution kernel has a size of n, and the output channel is 1, to obtain the comprehensive feature expression Zs of the crop feature data. The output feature map of crop feature data can refer to the following formula (9):

$$Zs = [ \begin{matrix}Z \\ {Z}_{j + d} \\ {Z}_{j + 2 d} \\ ⋮ \\ {Z}_{j + md}\end{matrix} ] \qquad ( 9 )$$

where Zs denotes a comprehensive feature expression of crop feature data, Z denotes the crop data input, j denotes a starting time point (starting time), d denotes a sampling interval (every day), and m denotes the number of sampling points.

In step S2.4, feature coupling is performed. The fused meteorological, soil and crop features are coupled by an MLP neural network. The input layer consists of three neurons, representing the three input features of meteorology, soil and crops, respectively. The output consists of a neuron, representing the comprehensive feature expression of the three features after being coupled. The structure of its comprehensive input data MX can refer to the following formula (10):

$$MX = [ \begin{matrix}{Q}_{j} & {T}_{j} & {Z}_{j} \\ {Q}_{j + d} & {T}_{j + d} & {Z}_{j + d} \\ {Q}_{j + 2 d} & {T}_{j + 2 d} & {Z}_{j + 2 d} \\ ⋮ & ⋮ & ⋮ \\ {Q}_{j + md} & {T}_{j + md} & {Z}_{j + md}\end{matrix} ] \qquad ( 10 )$$

where MX denotes the comprehensive input data, Qⱼ, Tⱼ and Zⱼ denote the comprehensive feature expressions of meteorology, soil and crops respectively, j denotes a starting time point (starting time), d denotes a sampling interval (every day), and m denotes the number of sampling points.

When the input vector of the MLP is constructed as X=(QⱼTⱼ Zⱼ), the weight vector is constructed as W=[w₁, w₂, w₃, . . . , wₙ], and a bias term is b, the output of the model is represented by the following formula (11):

$$y = f ( W * X + b ) \qquad ( 11 )$$

where y denotes a comprehensive feature expression output by the multilayer perceptron neural network, X denotes the input vector of the multilayer perceptron neural network, W denotes the weight vector, b denotes the bias term, and ƒ denotes a function of the multilayer perceptron neural network.

According to the embodiment of the present disclosure, multi-source information is coupled through the one-dimensional convolution and the MLP algorithm. The mutual relationship between features can be automatically explored, the interaction and nonlinearity between features can be captured, the complexity of data can be better expressed, and the original features can be combined into more meaningful high-order features, thereby reducing the feature dimension and reducing the complexity of model training.

In the method for the large-scale prediction on water requirement of crop based on the spatiotemporal fusion model under the physical constraint according to the present disclosure, the inputting the comprehensive feature expression into a trained spatiotemporal feature fusion model to obtain a prediction result of water requirement of crop at the target time output by the trained spatiotemporal feature fusion model, includes:
determining target nodes corresponding to the meteorological data at the target time, the soil data at the target time and the crop data at the target time in the comprehensive feature expression;
performing weighted aggregation on features of neighborhood nodes of the target node through the graph convolution network model of the trained spatiotemporal feature fusion model to obtain the spatial features of the target node;
determining a long time sequence of the comprehensive feature expression based on a self-attention mechanism through the Informer model of the trained spatiotemporal feature fusion model; and determining the temporal features of the target node based on the long time sequence of the comprehensive feature expression; and
determining the prediction result of water requirement of crop at the target time based on the spatial features of the target node and the temporal features of the target node through the trained spatiotemporal feature fusion model.

In order to combine the spatial position information of different areas and the historical change law of each station data, the present disclosure constructs a spatiotemporal feature fusion model of the GCN-Informer, where the Graph Convolution Network (GCN) performs weighted aggregation on the features of neighborhood nodes through the graph structure to extract spatial features. The Informer uses a self-attention mechanism to model the long-term dependence in temporal data and extract the important features hidden in temporal data, which specifically includes steps S3.1-S3.2.

In step S3.1, the spatial feature is extracted by the GCN. The GCN is a variant of the multilayer Convolutional Neural Network (CNN), which can learn features from an unstructured graph operating directly on the network. The GCN acts as a feature extractor, just like the CNN, which learns each node by iteratively aggregating the feature information from its topological neighbors and fusing the feature information. The information of the target node is derived by the GCN using data from other nodes. If there is a batch of data with N_{w} nodes, each node has its own feature number D_{w} and forms a feature matrix X_{w} of N_{w}×D_{w}. Thereafter, the relationship between respective nodes will also form an adjacency matrix A_{w} of N_{w}×N_{w}, where X_{w} and A_{w} denote the input of the GCN.

The GCN algorithm depends on the use of a Laplacian matrix, which is usually used to represent graphs in a graph theory. For a graph G₁=(V_{w}, E_{w}), its Laplacian matrix is defined as L_{w}=D_{w}−A_{w}, where L_{w} denotes a Laplacian matrix, D_{w} denotes a degree matrix of a vertex, which indicates how many degrees each node has, that is, how many edges are connected to the node, and A_{w} denotes an adjacency matrix of the graph. The specific steps and formulas of the GCN algorithm include step S3.1.1-S3.1.4.

In step S3.1.1, the core of the GCN algorithm is spectral decomposition based on the Laplacian matrix. For a Laplacian matrix, its spectral decomposition is

$${L}_{w} = {U}_{w} Λ {U}_{W}^{T} ,$$

where L_{w} denotes a Laplacian matrix, A denotes a diagonal matrix of feature values, U_{w} denotes a vector (orthogonal matrix) including feature vectors, and

$${U}_{W}^{T}$$

denotes a transposed matrix of the orthogonal matrix U_{w}.

In step S3.1.2, convolution operation is performed on the graph. Refer to the following formula (12) for details:

$${g}_{θ} \times x = {U}_{w} {g}_{θ} ( Λ ) {U}_{W}^{T} x \qquad ( 12 )$$

where g_{θ}×x denotes the graph convolution operation on the feature vector x. First, the Fourier transform of the feature vector x, that is,

$${U}_{W}^{T} x ,$$

is input, and then the Fourier transform result is scaled, that is,

$${g}_{θ} ( Λ ) {U}_{W}^{T} x .$$

Finally, the scaled Fourier transform result is inverted to obtain

$${U}_{w} {g}_{θ} ( Λ ) {U}_{W}^{T} x .$$

In step S3.1.3, in order to simplify the solution of graph convolution, first, a disordered table of multinomial distributions g_{θ}(Λ)=θ₀Λ₀+θ₁Λ₁+ . . . +θₙΛₙ is defined. The above formula (12) is transformed into the following formula (13) by polynomials:

$${U}_{w} {g}_{θ} ( Λ ) {U}_{W}^{T} x = {g}_{θ} ( {U}_{w} Λ {U}_{W}^{T} ) x \qquad ( 13 )$$

where g_{θ}(Λ) is a disordered table of multinomial distributions, Λ denotes a diagonal matrix of feature values, U_{w} denotes a vector (orthogonal matrix) including feature vectors,

$${U}_{W}^{T}$$

denotes a transposed matrix of the orthogonal matrix U_{w}, and x denotes an input feature.

Thereafter, a Chebyshev formula is used to simplify the calculation. The description of the Chebyshev formula is given in formula (14) as follows:

$${T}_{w n} ( x ) = 2 x {T}_{w n - 1} ( x ) - {T}_{w n - 2} ( x ) \qquad ( 14 )$$

where T_{w0}(x)=1, T_{w1}(x)=x, and the feature values belong to [−1,1]. Every Chebyshev polynomial T_{wn}(x) can be obtained by the linear combination of the first two polynomials T_{wn-1}(x) and T_{wn-2}(x) and the variable x. This recurrence relation makes it possible to construct higher-order Chebyshev polynomials step by step from the basic polynomials T_{w0}(x) and T_{w1}(x).

Because the feature value of L is between [0,2], L_{w}=L_{w}−E can be defined, where L_{w} denotes a Laplacian matrix, “=” is used for assignment, and E denotes a matrix which is isomorphic to the Laplacian matrix L_{w} and is used to adjust the feature values of the Laplacian matrix L_{w}, so that its feature values can be mapped to [−1,1]. Finally, the graph convolution formula is rewritten as the following formula (15):

$$\begin{matrix}{g}_{( θ )} \times x = {U}_{w} ( {\sum }_{k = 0}^{k} {T}_{k} ( Λ ) ) {U}_{W}^{T} x \\ = {\sum }_{k = 0}^{k} {T}_{k} ( {U}_{w} Λ {U}_{W}^{T} ) x \\ = {\sum }_{k = 0}^{k} {T}_{k} ( {L}_{w} - E ) x .\end{matrix} \qquad ( 15 )$$

According to the empirical value, K is set to 1, that is, the first order is approximately θ₀x+θ₁(L_{w}−E)x, and θ₀ and θ₁ denote two shared parameters, where g_{(θ)}×x denotes the graph convolution operation on the feature vector x, L_{w} denotes the Laplacian matrix, Λ denotes a diagonal matrix of feature values, U_{w} denotes a vector (orthogonal matrix) including feature vectors,

$${U}_{W}^{T}$$

denotes a transposed matrix of the orthogonal matrix U_{w}, and Tₖ denotes a k-th term of the Chebyshev polynomial about Λ.

In step S3.1.4, parameters are shared so that θ₀=−θ₁. The final formula can be organized as the following formula (16):

$${g}_{( θ )} \times x = θ ( E + {D}_{w}^{- \frac{1}{2}} {A}_{w} {D}_{w}^{- \frac{1}{2}} ) \qquad ( 16 )$$

$$x = {\tilde{D}}_{w}^{- \frac{1}{2}} {Ã}_{w} {\tilde{D}}_{w}^{- \frac{1}{2}} X Θ$$

Finally, the layer-to-layer propagation formula of the GCN can refer to the following formula (17):

$${H}_{w}^{( l + 1 )} = σ ( {\tilde{D}}_{w}^{- \frac{1}{2}} \tilde{{A}_{w}} {\tilde{D}}_{w}^{- \frac{1}{2}} {H}_{w}^{( l )} {W}_{w 1}^{( l )} ) \qquad ( 17 )$$

$${H}_{w}^{( l + 1 )}$$

where θ denotes a learnable parameter, D_{w} denotes a degree matrix, a layer-to-layer propagation formula of the GCN, Ã_{w}=A_{w}+E, A_{w} denotes an information matrix including other matrix nodes connected to the node A_{w}, E denotes an identity matrix, and \tilde{D}_{w} denotes a degree matrix of Ã_{w}. Θ denotes a trainable parameter matrix. σ denotes a nonlinear activation function, and leakyrelu is used in the present disclosure. The weight matrix of the l-th layer of the neural network is designated as

$${W}_{w 1}^{( l )} . {H}_{w}^{( l )} ∈ {R}^{N \times D}$$

denotes the feature

$${H}_{w}^{( 0 )} = X$$

of the L-th layer. Through the GCN model, the features of the neighboring stations around a station can be aggregated, the spatial dependence of different stations is established, and the data from other nodes is made full use of, so as to infer the information of the node.

In step S3.2, the temporal feature is extracted by the Informer. The Informer is a time sequence forecasting model based on a Transformer. Compared with the traditional Transformer, the Informer has three unique features: a ProbSparse Self-attention mechanism, a Self-attention Distilling mechanism, and parallel concurrent generation of a prediction sequence (One forward operation) using a decoder architecture.

The ProbSparse Self-attention mechanism reduces the computational complexity by performing sparsification on the attention matrix. The Self-attention Distilling technology is a technology that compresses the output of a multi-head attention mechanism to obtain a more compact feature representation, reduces the model parameters and the computational complexity, and enables the Informer to process an extremely long input sequence efficiently. The mechanism of parallel concurrent generation of the prediction sequence can directly predict all the target values in one forward operation, without decoding step by step like the traditional decoder.

The ProbSparse Self-attention mechanism achieves the optimization of the time complexity of dot product calculation of the self-attention mechanism from O(L²) to O(1*log L), and its calculation steps includes steps S3.2.1-S3.2.5.

In step S3.2.1, for each query, the partial key is randomly sampled, and the default value is 5*ln L, where L is the length of the input sequence.

In step S3.2.2, sparsity scores M (qᵢ, k) between each query and all keys are calculated. The sparsity score reflects the correlation between the query and the key. The higher the score, the stronger the correlation.

In step S3.2.3, the top N queries with the highest sparsity score are selected, where the default value of N is 5*ln L.

In step S3.2.4, the dot product results of N queries and keys are calculated to obtain attention results.

In step S3.2.5, attention calculation is not performed on the remaining L-N queries. These queries directly average all the inputs from the attention layer for output, thus ensuring that the input sequence length and output sequence length of the ProbSparse layer are both L.

The ProbSparse Self-attention mechanism optimizes the matrix form into the probability form. Refer to the following formulas (18) and (19) for details:

$$A ( Q , K , V ) = Softmax ( \frac{Q {K}^{T}}{\sqrt{d}} ) V \qquad ( 18 )$$

where A denotes a self-attention mechanism, Q, K, V are input matrices representing a query, a key and a value, respectively, d denotes the feature dimension (usually the dimension of the embedding vector), QK^{T} denotes a dot product of the query matrix and transpositions of the key matrix, and Softmax is used to convert the attention score matrix into the probability distribution.

$$A ( {q}_{i} , K , V ) = {\sum }_{j} \frac{f ( {q}_{i} , {k}_{j} )}{Σ ι f ( {q}_{i} , {k}_{l} )} {v}_{j} = {E}_{p ( {k}_{j} \vert {q}_{i} )} [ {v}_{j} ] \qquad ( 19 )$$

where A(qᵢ, K,V) denotes an attention score, qᵢ denotes an i-th query, K denotes a set of keys, V denotes a set of values, and ƒ(qᵢ, kⱼ) denotes a kernel function

$$exp ( {q}_{i} {k}_{j}^{T} / \sqrt{d} ) ,$$

which measures the correlation between the i-th input and the j-th input, where d denotes the dimension of the input feature. qᵢ, kⱼ, vⱼ denote the i-th row of the Q, K, V matrices, respectively. Q, K, V denote a query matrix, a key-value matrix and a value matrix, respectively, T denotes a transpose symbol, and

$$\frac{f ( {q}_{i} , {k}_{j} )}{{Σ}_{l} f ( {q}_{i ,} {k}_{l} )}$$

denotes the attention weight of qᵢ to kⱼ, that is, the proportion of kⱼ in the attention distribution of qᵢ on all keys.

$${Σ}_{j} \frac{f ( {q}_{i} , {k}_{j} )}{{Σ}_{l} f ( {q}_{i} , {k}_{l} )}$$

denotes a weighted sum of all keys, that is, the attention output of qᵢ. Eₚ₍ₖ_{ⱼ}_{|q}_{ᵢ}₎[vⱼ] denotes the expectation of choosing vⱼ from V under the condition that the above weighted sum is interpreted as the given qᵢ.

The attention degree of the i-th q to all k is defined as the probability p(kⱼ|qᵢ). If p(kⱼ|qᵢ) is close to the uniform distribution q(kⱼ|qᵢ)=1/Lₖ, the “sparsity” between the distributions p and q can be used to distinguish “important” queries. Its sparsity is quantitatively described by calculating the KL divergence of p and q. Refer to the following formula (20) for details:

$$K L ( q ‖ p ) = ln {Σ}_{l = I}^{{L}_{k}} {e}^{{q}_{i} {k}_{l}^{T} / \sqrt{d}} - \frac{1}{{L}_{k}} {Σ}_{j = I}^{{L}_{k}} {q}_{i} {k}_{j}^{T} / \sqrt{d} - ln {L}_{k} \qquad ( 20 )$$

where p denotes the real distribution, q denotes the model distribution, d denotes the dimension of the input features, qᵢ denotes the i-th row of Q matrix, k; denotes the j-th row of K matrix, T denotes the transposed symbol, Lₖ denotes a length of K matrix,

$${k}_{l}^{T}$$

denotes a transposition of K matrix with length l, and e denotes a natural logarithm.

The constant term is discarded, and finally the “sparsity measure” of the i-th query is defined, which can refer to the following formula (21):

$$M ( {q}_{i} , K ) = ln {Σ}_{l = I}^{{L}_{k}} {e}^{{q}_{i} {k}_{l}^{T} / \sqrt{d}} - \frac{1}{{L}_{k}} {Σ}_{j = I}^{{L}_{k}} {q}_{i} {k}_{j}^{T} / \sqrt{d} \qquad ( 21 )$$

where M (qᵢ, K) denotes the sparsity measure, qᵢ denotes the i-th query, and K denotes a set of keys. The first term is the logarithm and exponent (LSE) of qᵢ on all keys, and the second term is the arithmetic mean of qᵢ on all keys.

Finally,

$${max}_{j} \{ \frac{{q}_{i} {{k}_{j}}^{T}}{\sqrt{d}} \}$$

is used to replace ln

$${Σ}_{l = 1}^{{L}_{k}} {e}^{{q}_{i} {k}_{j}^{T} / \sqrt{d}} .$$

The formula is further simplified, and the approximate sparsity evaluation result is shown in formula (22):

$$\overline{M} ( {q}_{i} , K ) = {max}_{j} \{ \frac{{q}_{i} {k}_{j}^{T}}{\sqrt{d}} \} - \frac{1}{{L}_{k}} {Σ}_{j = 1}^{L} \{ \frac{{q}_{i} {k}_{j}^{T}}{\sqrt{d}} \} \qquad ( 22 )$$

where the meanings of qᵢ, kⱼ, K, d, Lₖ parameters are consistent with the above formula, which will not be not described in detail here.

### The Self-Attention Distilling Mechanism Specifically Includes:

in the encoding layer of the Informer, using the self-attention distilling mechanism for the second time; down-sampling the input sequence by two operations of one-dimensional convolution and max-pooling, and then carrying out sparse attention operation, which are expressed as formula (23):

$${X}_{2}^{t} = MaxPooling ( E LU ( Conv 1 {d ( {X}_{1}^{t} )}_{a t t e n} ) ) \qquad ( 23 )$$

where

$${X}_{2}^{t}$$

denotes an input matrix of sparse self-attention temporal feature at a second level;

$${( {X}_{1}^{t} )}_{a t t e n}$$

denotes the temporal feature matrix at a first level after the sparse self-attention operation, and d denotes the input, which is activated by using the Exponential Linear Unit (ELU) function after one-dimensional convolution operation (Conv1), and then is subjected to MaxPooling to obtain

$${X}_{2}^{t} .$$

### Parallel Concurrent Generation of the Prediction Sequence Using a Decoder Architecture Includes:

setting a time sequence Xₜₒₖₑₙ before the time point to be predicted as the first part of the decoder input sequence, and setting the corresponding all-0 input sequence X_{placeholder} at the position to be predicted as the latter part of the decoder input; generating all prediction outputs at one time based X_{feed_decoder} by the Informer model, which is expressed by calculation formula (24):

$${X}_{feed \_ decoder} = Concat ( {X}_{token} , {X}_{placeholder} ) ∈ {R}^{( {L}_{token} + {L}_{r l} ) \times {d}_{model}} \qquad ( 24 )$$

where X_{feed_decoder} is the result of concatenating two tensors Xₜₒₖₑₙ and X placeholder through Concat operation, Xₜₒₖₑₙ is a tensor with the shape of Lₜₒₖₑₙ×d_{model}, where Lₜₒₖₑₙ denotes the number (length) of token in the input sequence, d_{model} denotes the embedded dimension (or model dimension) of each token; X_{placeholder} denotes a tensor with the shape of Lᵣₗ×d_{model}, where Lᵣₗ denotes length of transmitted placeholder or specific tag, and R denotes matrix space.

The informer model can effectively capture the long-term dependence in temporal data, which overcomes the problem that it is difficult for the traditional RNN model to model a long sequence. At the same time, the Informer gets rid of the restriction of the sequential computing of the RNN and can perform parallel computing, which greatly improves the reasoning efficiency and makes better use of historical information to accurately predict a plurality of time steps in the future.

To sum up, the construction of the GCN-Informer spatiotemporal feature fusion model can better mine the spatiotemporal dependence hidden in data and improve the prediction precision. At the same time, the Informer improves the prediction ability of the long sequence, and can predict data for a plurality of time step at one time, which greatly improves the prediction efficiency.

In the method for the large-scale prediction on water requirement of crop based on the spatiotemporal fusion model under the physical constraint according to the present disclosure, the method further includes the following steps:
inputting the training sample set into a preset WOFOST physical model to obtain a simulated water requirement of crop output by the preset WOFOST physical model;
inputting the training sample set into the preset spatiotemporal feature fusion model to obtain a predicted water requirement of crop output by the preset spatiotemporal feature fusion model; and
determining a loss function of the preset spatiotemporal feature fusion model under a constraint of the WOFOST physical model based on a real water requirement of crop, the simulated water requirement of crop and the predicted water requirement of crop of the training sample set.

At present, most of the methods for predicting the water requirement of crop based on the statistical model are data-driven, but the methods need a lot of labeled data, which is easily influenced by uneven data distribution and noise. Moreover, the quality of data determines the model effect. If the data is missing or the quality of data is poor, the model often shows instability or inaccurate prediction on new data. However, physical constraints can constrain or standardize the model based on known physical laws or domain knowledge to ensure that the prediction results of the model conform to the physical laws of the real world.

In the embodiment of the present disclosure, in the prediction on water requirement of crop, physical constraints are introduced, which can help the model to better understand and interpret data, improve the robustness and the accuracy of the model, and reduce the risk of overfitting.

In the prediction on water requirement of crop, physical constraints are introduced, which can help the model to better understand and interpret data. By introducing the physical mechanism of crop growth, such as a transpiration process, soil water content and other factors, the model can be effectively constrained in the process of predicting the water requirement of crop, so that it is more in line with the real situation, which not only can improve the interpretability of the model, but also allow the prediction results of the model to be more reasonable and better guide agricultural production practice.

The present disclosure uses a WOFOST to constrain model training. The WOFOST can be used for long-term simulation, and can simulate the whole crop growth period, including sowing, growth, harvesting and other stages. The WOFOST has accumulated a lot of experimental data, which can be used to verify the accuracy of the model and make it a powerful tool for the decision support and the policy analysis. The principle of the WOFOST model is as follows.

Phenological development: the development rate of each growth period is influenced by the temperature and photoperiod. In the WOFOST model, crop growth period is represented by a dimensionless state variable-Development Stage (DVS). When crops emerge, DVS=0; in florescence, DVS=1; and when the crops reach maturity, DVS=2. The formula (25) is as follows:

$$DVS = \frac{\int {T}_{e}}{{T}_{r e q}} \qquad ( 25 )$$

where DVS denotes a developmental stage, ∫ Tₑ denotes an accumulated temperature, and T_{req} denotes an accumulated temperature needed for the crop development to enter next stage.

The development rate of some crops is also influenced by the photoperiod, and the formula (26) for calculating the photoperiod influencing factor Fₚᵣ is as follows:

$${F}_{pr} = \frac{p - {p}_{c}}{{p}_{0} - {p}_{c}} , 0 ⩽ {F}_{pr} ⩽ 1 \qquad ( 26 )$$

where Fₚᵣ denotes a photoperiod influencing factor, p denotes an actual photoperiod (actual sunshine duration), p₀ denotes an optimal photoperiod, and p_{c} denotes a critical photoperiod. The DVS of its developmental stage is calculated by Formula (27):

$$DVS = {F}_{pr} \frac{\int {T}_{e}}{{T}_{r e q}} \qquad ( 27 )$$

where DVS denotes a developmental stage, ∫ Tₑ denotes an accumulated temperature, T_{req} denotes an accumulated temperature needed for the crop development to enter next stage, and Fₚᵣ denotes a photoperiod influencing factor.

Assimilation and respiration: assimilation represents the process by which plants convert carbon dioxide and water into organic substances through photosynthesis. Respiration represents the process by which plants decompose organic substances into carbon dioxide and water, releasing energy for sustaining life activities. The assimilation rate of crops in the WOFOST is calculated by Formula (28):

$${A}_{L} = {A}_{m} ( 1 - {e}^{- ε \frac{{I}_{{α}_{L}}}{{A}_{m}}} ) \qquad ( 28 )$$

where A_{L} denotes a total assimilation rate, Aₘ denotes a maximum total assimilation rate, ε denotes a utility rate of the original luminous energy of a simple leaf, ε and Aₘ are related to temperature, Aₘ is determined by the property of crops, and I_{α}_{_{L}} denotes the radiation absorbed by the leaf layer L, in which its formula (29) is as follows:

$${I}_{{α}_{L}} = k \cdot ( 1 - ρ ) \cdot {I}_{0} \cdot {e}^{- k \cdot LAI} \qquad ( 29 )$$

where I_{α}_{_{L}} denotes the radiation absorbed by the leaf layer L, and k denotes an extinction coefficient, which is a function of the radiation property, the solar elevation angle, the leaf angle distribution and the simple-leaf divergence coefficient; ρ is a reflection coefficient, which is a function of the solar elevation angle, the leaf angle distribution and the leaf reflection, and the conduction performance; LAI denotes a leaf area index; e denotes a natural logarithm; I₀ denotes the canopy radiation in sunny days, which may refer to the following formula (30):

$${I}_{0} = I \cdot sin β \qquad ( 30 )$$

where I denotes a solar constant, and β denotes an angle between the sun and the earth's surface.

Transpiration indicates that the pores (gas holes) on the surface of leaves will continuously release water into the air, reduce the temperature of leaves, help plants regulate their body temperature and prevent overheating. The reference crop evapotranspiration in the WOFOST is calculated by the following formulas (31) to (33):

$${E}_{T 0} = \frac{( Δ \times {R}_{n a} + γ \times {E}_{A} )}{Δ + γ} \qquad ( 31 )$$

$${E}_{A} = 0.26 \times {V}_{PD} \times ( F + {B}_{U} \times {U}_{2} ) \qquad ( 32 )$$

$${B}_{U} = \{ \begin{matrix}0.54 + 0.35 \times \frac{{T}_{D} - 12}{4} , {T}_{D} ⩾ 12 ° C . \\ 0.54 , {T}_{D} < 12 ° C .\end{matrix} \qquad ( 33 )$$

where E_{T0} denotes a reference evapotranspiration rate, Rₙₐ denotes an evapotranspiration rate caused by the net absorbed radiation, E_{A} denotes a evaporation demand, Δ denotes a slope of a saturated vapor pressure curve, γ denotes a dry-wet bulb constant, V_{PD} denotes a vapor pressure deficit at 2 m height, B_{U} denotes an empirical coefficient of a wind function, U₂ denotes a 24-hour average wind velocity at 2 m height, T_{D} denotes a temperature daily range, and F denotes an empirical parameter, in which the vegetation canopy is 1, and the evaporation from water surface is 0.5. A correction coefficient can be used among different crops to calculate and in turn obtain the potential evapotranspiration E_{TC}. Refer to the following formula (34) for details:

$${E}_{TC} = {K}_{c} \times {E}_{T 0} \qquad ( 34 )$$

where E_{TC} denotes a potential evapotranspiration, K_{c} denotes a correction coefficient, and E_{T0} denotes a reference evapotranspiration rate. The utilization coefficient of most crops is 1, the utilization coefficient of water-saving crops is 0.8, and the utilization coefficient of water-storing crops is 1.2.

The actual crop evapotranspiration is equal to the potential evapotranspiration multiplied by the light interception rate, the water stress and the correction factors of general crops. When crops respond to the water stress by closing gas holes, the closure of the gas holes leads to a decrease in the exchange of O₂ and CO₂ between crops and the atmosphere, and the assimilation rate of CO₂ also decreases. At this time, the actual crop evapotranspiration calculation formula (35) is as follows:

$${E}_{TA} = \frac{A}{{A}_{P}} \cdot {E}_{T C} \qquad ( 35 )$$

where A denotes an assimilation rate, Aₚ denotes a potential assimilation rate, E_{TA} denotes an actual evapotranspiration, and E_{TC} denotes a potential evapotranspiration.

Field soil water balance: according to the factors such as precipitation, infiltration, evaporation, transpiration and drainage, the soil water content and the water deficit of each layer in the soil profile are calculated. There are three sub-modules of soil moisture in the WOFOST. First, under the potential production condition, the soil is constantly moist, and the water requirement of crop is quantified as crop transpiration and the amount of water evaporated from the soil surface covered by the canopy. Second, under the water-limited production condition, the water in the soil can flow freely, and the underground water level of such soil is too deep to influence the soil water content in the root zone. Third, under the water-limited production condition, the water balance is influenced by the shallow groundwater in the root zone. This sub-module is similar to the second case, except that the soil water holding capacity is determined by the depth of the underground water level, there is capillary supporting water, and the water content in the root zone does not change with the depth.

The soil in the model is divided into three parts: the actual root zone (RDact), the part below the actual root zone to the underground water level, and the part below the underground water level to the position which is 1000 cm away from the surface soil layer. The maximum root depth is RDm, and the depth of the underground water level is Z. When the groundwater enters the root zone, the root zone is subdivided into a saturated zone and an unsaturated zone of water. The calculation of the water flux includes precipitation (R), surface storage water (SS), surface runoff (SR), —soil evaporation (E), crop transpiration (T), water (PC) penetrating to the deeper soil layer from the root zone, and capillary supporting water (CR) rising to the root zone. The soil water balance formula can be expressed by the following formula (36):

$$Δ W = R + SS - SR - E - T - PC + CR \qquad ( 36 )$$

where Δ W denotes soil water balance, R denotes precipitation, SS denotes surface storage water, SR denotes surface runoff, E denotes soil evaporation, T denotes crop transpiration, PC denotes water penetrating to the deeper soil layer from the root zone, and CR denotes capillary supporting water rising to the root zone.

In machine learning and deep learning, the loss function is used to guide the training process of the model. By minimizing the loss function, the parameters of the model can be adjusted to better fit the training data and improve the performance of the model. In the regression forecasting task, the commonly used loss function is MSE, and its specific formula (37) is as follows:

$$MSE = \frac{1}{m} {\sum }_{i = 1}^{m} {( {y}_{i} - {\hat{y}}_{i} )}^{2} \qquad ( 37 )$$

where MSE denotes a mean square error, yᵢ denotes a real water requirement value of crop of the i-th sample, ŷᵢ denotes the predicted water requirement value of crop of the i-th sample, and m denotes the total number of samples.

If only the loss function of the pure difference is used without any physical constraints, the model may learn some solutions that are mathematically feasible but actually do not conform to the physical laws. Such solutions may be meaningless in the practical application. Therefore, the present disclosure embeds the formula for calculating the water requirement of the WOFOST physical model into the loss function. Therefore, the formula of the loss function of the model is as follows:

$$LOSS = \frac{1}{m} {\sum }_{i = 1}^{m} {( {y}_{i} - {\hat{y}}_{i} )}^{2} + λ * \frac{1}{m} {\sum }_{i = 1}^{m} {( {\hat{y}}_{i} - {\hat{y}}_{w i} )}^{2} \qquad ( 38 )$$

where LOSS denotes a loss function, and λ denotes a weight coefficient of the water requirement term, which can be determined by adjusting parameters. yᵢ denotes a real water requirement value of crop, and ŷᵢ denotes a predicted water requirement value of crop. ŷ_{wi} denotes the water requirement of crop E_{TC} simulated by the WOFOST model (refer to formula 34 for details). m denotes the total number of samples, and i denotes a sample index.

Therefore, the above methods can constrain the model training under the physical mechanism of the WOFOST, ensure that the model not only fits the observed data, but also conforms to the physical law of the water requirement of crop described by the WOFOST model in the learning process of the model, help improve the interpretability and the robustness of the model, and thus enhance its application ability in the actual irrigation areas.

In the method for the large-scale prediction on water requirement of crop based on the spatiotemporal fusion model under the physical constraint according to the present disclosure, before inputting the comprehensive feature expression into a trained spatiotemporal feature fusion model to obtain a prediction result of water requirement of crop at the target time output by the trained spatiotemporal feature fusion model, the method further includes:
acquiring multi-source data samples, and dividing the multi-source data samples into a training sample set and a test sample set according to a preset proportion;
training a preset spatiotemporal feature fusion model based on the training sample set, and performing gradient updating on the preset spatiotemporal feature fusion model based on an Adaptive Moment Estimation (Adam) optimizer to obtain the trained spatiotemporal feature fusion model; and
evaluating the trained spatiotemporal feature fusion model based on a root mean squared error (RMSE), a mean absolute error (MAE) and a determination coefficient (R2) to obtain the trained spatiotemporal feature fusion model.

According to the method, historical data is divided into a training set and a test set in a ratio of 8:2. The training set is used to train the model. The test set is used to evaluate the model. The Adam optimizer is used for gradient updating in the training. Three parameters, that is, RMSE, MAE and R², are selected as the evaluation indexes of the model.

Adaptive Moment Estimation (Adam) is a widely used deep learning optimization algorithm, which combines the ideas of momentum and root mean square propagation (RMSProp), and aims at adjusting the learning rate of each parameter by calculating the first-order moment estimation and the second-order moment estimation of the gradient, so as to achieve more efficient network training.

The Root Mean Square Error (RMSE) is a typical index of a regression model, which is used to indicate how large the error will be in model prediction. For larger errors, the weight is higher. The specific formula (39) is as follows:

$$RMSE = \sqrt{\frac{1}{m} {\sum }_{i = 1}^{m} {( {y}_{i} - {\hat{y}}_{i} )}^{2}} \qquad ( 39 )$$

where RMSE denotes a root mean square error, m denotes the total number of samples, i denotes a sample index, yᵢ denotes an actual value, and ŷᵢ denotes a predicted value, in which the smaller the RMSE is, the better the model performance.

The Mean Absolute Error (MAE) is a non-negative value, which is the mean absolute error used to make a balance between the predicted value and the real value. The smaller MAE indicates that the model is better. The specific formula (40) is as follows:

$$MAE = \frac{1}{n} {\sum }_{i = 1}^{n} \vert {\hat{y}}_{i} - {y}_{i} \vert \qquad ( 40 )$$

where MAE denotes a mean absolute error, yᵢ denotes an actual value, ŷᵢ denotes a predicted value, n denotes the total number of samples, and i denotes a sample index.

The determination coefficient (R²) is another commonly used index to evaluate the performance of the linear regression model. R² denotes a ratio of the dependent variable variation to the total variation explained by the model, and the specific formula (41) is as follows:

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}} \qquad ( 41 )$$

where R² denotes a determination coefficient, yᵢ denotes an actual value, ŷᵢ denotes a predicted value, n denotes the total number of samples, and i denotes a sample index.

Through the above methods, the model training process is monitored, the optimal model weight in the training and evaluation process is saved and deployed in the production environment, its prediction effect on new data is continuously monitored, and the model is retrained and optimized in time.

The present disclosure provides a multi-source information coupling method, which comprehensively utilizes meteorological, soil and crop data, and designs a data coupling method of One-dimensional Convolutional Neural Network-Multilayer Perceptron (1DCNN-MLP), which integrates the features of various types of data through a one-dimensional convolution, and obtains the comprehensive feature expression of meteorological, soil and crop features, and then uses the MLP neural network to fuse the three features as the feature input of the subsequent model. This method uses one-dimensional convolution to capture the correlation and potential patterns between different data of the same type. Compared with manually designed features, the automatic feature extraction method is more efficient. Moreover, the MLP has a good nonlinear fitting ability, which can effectively capture the complex interaction between different features, thus achieving better feature fusion. This method makes full use of the advantages of multi-source data and technical methods, and makes innovations in feature engineering and feature fusion, which can improve the prediction performance and the generalization ability of the model.

The present disclosure puts forward a spatiotemporal feature fusion model under a physical constraint to predict the water requirement of crop. The present disclosure designs a GNN and Informer-based spatiotemporal feature fusion model by using the deep learning technology. This model makes full use of the advantages of the spatial structure feature expression of the graph convolution and the long-term memory ability of the Informer, which can effectively learn the interactive relationship between data of different stations and the time trend change of historical data. In addition, in the model training, the present disclosure also uses the WOFOST crop model as the physical constraint to be embedded into the loss function of the model, so as to ensure that the model not only fits the observed data, but also conforms to the physical law of the water requirement of crop described by the WOFOST model in the learning process. This method integrates the advantages of different deep learning models and crop models, and makes innovations in model construction and model training, which can effectively improve the prediction precision of the water requirement of crop and the robustness of the model.

According to the embodiment of the present disclosure, the feature expression ability is enhanced; the features of meteorological, soil and crop data are automatically extracted through the 1DCNN-MLP, and the correlation and potential patterns between different types of data are fully captured, so that the comprehensiveness of the feature expression is improved. The generalization and the accuracy of the model are improved. The GNN and Informer models are fused, so that the interaction between data of different stations and the time trend of historical data can be captured more effectively, thus improving the generalization ability of the model in different areas and the prediction precision of the water requirement of crop. The robustness of the model is enhanced; the WOFOST crop model is introduced as a physical constraint, which helps to ensure that the model not only fits the observed data, but also conforms to the established physical laws of the water requirement of crop, and improves the robustness and reliability of the model.

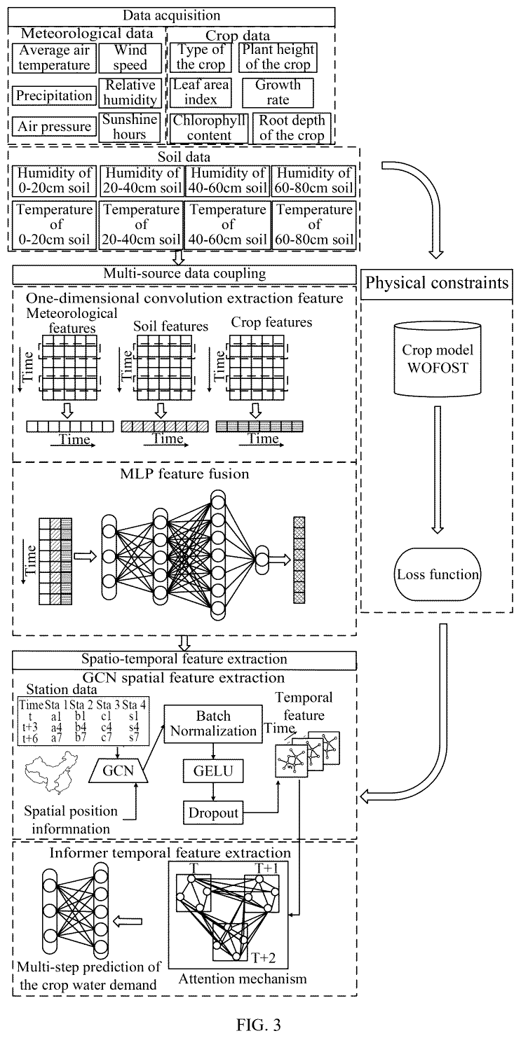

Referring to FIG. 3, FIG. 3 is a schematic diagram of a technical idea of a method for a large-scale prediction on water requirement of crop based on a spatiotemporal fusion model under a physical constraint, which includes data acquisition, multi-source data coupling, spatiotemporal feature extraction and physical constraints.

The data acquisition includes: meteorological data (including average temperature, wind speed, precipitation, atmospheric pressure, relative humidity and sunshine duration), crop data (including a type of the crop, a plant height of the crop, a root depth of the crop, a leaf area index of the crop, chlorophyll content of the crop and a growth rate), and soil data (including soil humidity at 0-20 cm depth, soil temperature at 0-20 cm depth, soil humidity at 20-40 cm depth, soil temperature at 20-40 cm depth, soil humidity at 40-60 cm depth, soil temperature at 40-60 cm depth, soil humidity at 60-80 cm depth, soil temperature at 60-80 cm depth). Multi-source data coupling includes: one-dimensional convolution feature extraction and MLP feature fusion (refer to the above embodiment for details). Spatiotemporal feature extraction includes: GCN spatial feature extraction and Informer temporal feature extraction (refer to the above embodiment for details). Physical constraints include: the crop model WOFOST and the loss function (refer to the above embodiment for details).

Next, an example of a method for a large-scale prediction on water requirement of crop based on a spatiotemporal fusion model under a physical constraint according to the present disclosure in a specific application scenario will be described hereinafter.

Data acquisition: the meteorological parameters involved include air temperature, humidity, atmospheric pressure and wind speed, etc. These data are acquired by meteorological stations or the remote sensing technology of satellites. In addition, a soil moisture monitoring device acquires data every hour, and the data recorded by a soil moisture sensor covers temporal dimensions of years, months, days, hours, minutes and seconds. The measured dimension includes soil water content per volume at depths of 20 cm, 40 cm, 60 cm and 80 cm. Spatial dimension data includes longitude, latitude and elevation information, and parameters such as a battery capacity of a device are also recorded.

All the acquired data will be sent back to a data receiving program of a cloud server. In order to show the change of soil moisture more effectively, the data are processed and converted into a daily mean, that is, the mean of sampling data every 24 hours is calculated.

In terms of ensuring the quality and the reliability of data, a series of verification measures are implemented, including format check, extremum check, internal consistency check and time consistency check. All the selected data are verified to meet the quality standards, which provides a reliable basis for subsequent data analysis and related decision.

Model construction: in this example, the GNN and Informer models of deep learning are used, which can be implemented in Tensorflow framework through Python language. The WOFOST crop model can be achieved by Python Crop Simulation Environment (PCSE), which is a Python package for constructing the crop simulation model. Therefore, the two models can operate in the same environment, which provides a good basis for the integration of subsequent crop models and deep learning models.

Example verification results: according to the scheme design, the historical data of different stations with the same sampling interval are selected as the model input, and the GCN adjacency matrix is constructed according to the position relationship of stations. The historical data is divided into a training set and a test set in a ratio of 8:2. The GCN-Informer model is trained by the training set data. The optimal model weight is saved to make prediction on the test set. The prediction results show that R2 of the training set is 0.96, and R2 of the verification set is 0.94. Therefore, it can be seen that this method can accurately predict the water requirement of crop.

The device for the large-scale prediction on water requirement of crop based on the spatiotemporal fusion model under the physical constraint according to the present disclosure is described hereinafter. The device for the large-scale prediction on water requirement of crop based on the spatiotemporal fusion model under the physical constraint described hereinafter and the method for the large-scale prediction on water requirement of crop based on the spatiotemporal fusion model under the physical constraint described above can refer to each other correspondingly.

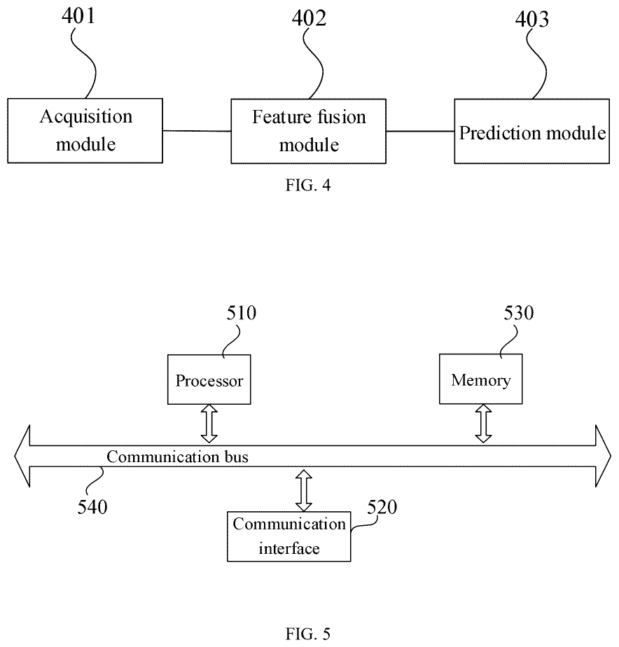

Referring to FIG. 4, FIG. 4 is a structural schematic diagram of a device for a large-scale prediction on water requirement of crop based on a spatiotemporal fusion model under a physical constraint, wherein the device includes an acquisition module 401, a feature fusion module 402 and a prediction module 403.

The acquisition module 401 is configured to acquire multi-source data at a starting time and multi-source data for at least one sampling interval, where the multi-source data includes meteorological data, soil data and crop data.

The feature fusion module 402 is configured to encode and fuse the multi-source data at the starting time and the multi-source data for at least one sampling interval by a one-dimensional convolution and a multilayer perceptron to obtain a comprehensive feature expression, where the comprehensive feature expression includes meteorological features at each time, soil features at each time and crop features at each time.

The prediction module 403 is configured to input the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

Specifically, the device for the large-scale prediction on water requirement of crop based on the spatiotemporal fusion model under the physical constraints according to the present disclosure can achieve all the method steps achieved by the embodiment of the method for the large-scale prediction on water requirement of crop based on the spatiotemporal fusion model under the physical constraints, and can achieve the same technical effect. Therefore, the same parts and beneficial effects in this embodiment as those in the method embodiment will not be specifically described in detail here.

FIG. 5 is a schematic diagram of a physical structure of an electronic device according to the present disclosure. As shown in FIG. 5, the electronic device may include a processor 510, a communication interface 520, a memory 530 and a communication bus 540, where the processor 510, the communication interface 520 and the memory 530 are communicated with each other through the communication bus 540. The processor 510 can call the logical instructions in the memory 530 to execute the method for the large-scale prediction on water requirement of crop based on the spatiotemporal fusion model under the physical constraint. The method includes: acquiring multi-source data at a starting time and multi-source data for at least one sampling interval, where the multi-source data includes meteorological data, soil data and crop data; encoding and fusing the multi-source data at the starting time and the multi-source data for at least one sampling interval by a one-dimensional convolution and a multilayer perceptron to obtain a comprehensive feature expression, where the comprehensive feature expression includes meteorological features at each time, soil features at each time and crop features at each time; and inputting the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

In addition, the above-mentioned logical instructions in the memory 530 can be achieved in the form of software functional units and can be stored in a computer-readable storage medium when they are sold or used as independent products. Based on this understanding, the essence of the technical scheme of the present disclosure, or the part of the technical scheme that contributes to the prior art, or the part of the technical scheme, can be embodied in the form of a software product. The computer software product is stored in a storage medium, and includes several instructions to cause a computer apparatus (which can be a personal computer, a server, a network device, etc.) to execute all or part of the steps of the method described in various embodiments of the present disclosure. The aforementioned storage medium includes various media that can store program codes such as: a USB flash drive, a mobile hard disk, a Read-Only Memory (ROM), a Random Access Memory (RAM), a magnetic disk or an optical disk.

In another aspect, the present disclosure further provides a computer program product, including a computer program which can be stored on a non-transitory computer-readable storage medium, where the computer program, when executed by a processor, can execute the method for the large-scale prediction on water requirement of crop based on the spatiotemporal fusion model under the physical constraint provided by the above methods. The method includes: acquiring multi-source data at a starting time and multi-source data for at least one sampling interval, where the multi-source data includes meteorological data, soil data and crop data; encoding and fusing the multi-source data at the starting time and the multi-source data for at least one sampling interval by a one-dimensional convolution and a multilayer perceptron to obtain a comprehensive feature expression, where the comprehensive feature expression includes meteorological features at each time, soil features at each time and crop features at each time; and inputting the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

In still another aspect, the present disclosure further provides a non-transitory computer-readable storage medium on which a computer program is stored, where the computer program, when executed by a processor, executes the method for the large-scale prediction on water requirement of crop based on the spatiotemporal fusion model under the physical constraint provided by the above methods. The method includes: acquiring multi-source data at a starting time and multi-source data for at least one sampling interval, where the multi-source data includes meteorological data, soil data and crop data; encoding and fusing the multi-source data at the starting time and the multi-source data for at least one sampling interval by a one-dimensional convolution and a multilayer perceptron to obtain a comprehensive feature expression, where the comprehensive feature expression includes meteorological features at each time, soil features at each time and crop features at each time; and inputting the comprehensive feature expression into a trained spatiotemporal feature fusion model to obtain a prediction result of water requirement of crop at a target time output by the trained spatiotemporal feature fusion model, where the spatiotemporal feature fusion model includes a graph convolution network model and an Informer model; the graph convolution network model is configured to extract spatial features of the comprehensive feature expression, and the Informer model is configured to extract temporal features of the comprehensive feature expression.

The apparatus embodiments described above are only schematic, in which the units described as separate components may or may not be physically separated. The components displayed as units may or may not be physical units, that is, the components may be located in one place or distributed to a plurality of network units. Some or all of the modules can be selected according to actual needs to achieve the purpose of this embodiment. Those skilled in the art can understand and implement the purpose without creative labor.

From the description of the above embodiments, those skilled in the art can clearly understand that each embodiment can be realized by means of a software plus necessary general hardware platform, and of course can also be realized by hardware. Based on this understanding, the essence of the above technical scheme or the part of the technical scheme that contributes to the prior art can be embodied in the form of a software product. The computer software product can be stored in a storage medium, such as an ROM/RAM, a magnetic disk, an optical disk, etc., and includes several instructions to cause a computer apparatus (which can be a personal computer, a server, a network device, etc.) to execute the methods described in various embodiments or some parts of the embodiments.

Finally, it should be explained that the above embodiments are only used to illustrate the technical scheme of the present disclosure, rather than limit the technical scheme. Although the present disclosure has been described in detail with reference to the above embodiments, those skilled in the art should understand that it is still possible to modify the technical schemes described in the above embodiments, or to substitute some technical features with equivalents. However, these modifications or substitutions do not cause the essence of the corresponding technical schemes to deviate from the spirit and the scope of the technical schemes of various embodiments of the present disclosure.

What is claimed is:

1. A method for large-scale prediction on crop water requirement based on a spatiotemporal fusion model under a physical constraint, comprising:
acquiring multi-source data at a starting time and multi-source data for at least one sampling interval, wherein the multi-source data at the starting time and the multi-source data for the at least one sampling interval comprise meteorological data, soil data and crop data;
encoding and fusing the multi-source data at the starting time and the multi-source data for the at least one sampling interval by a one-dimensional convolution and a multilayer perceptron to obtain a comprehensive feature expression, wherein the comprehensive feature expression comprises a meteorological feature at each time, a soil feature at each time and a crop feature at each time; and
inputting the comprehensive feature expression into a trained spatiotemporal feature fusion model to obtain a prediction result of crop water requirement at a target time output by the trained spatiotemporal feature fusion model, wherein the trained spatiotemporal feature fusion model comprises a graph convolution network model and an Informer model; the graph convolution network model is configured to extract spatial features of the comprehensive feature expression, and the Informer model is configured to extract temporal features of the comprehensive feature expression;
wherein a layer-to-layer propagation formula of the graph convolution network model refers to following formula:
$${H}_{w}^{( l + 1 )} = σ ( {\tilde{D}}_{w}^{- \frac{1}{2}} {\tilde{A}}_{w} {\tilde{D}}_{w}^{- \frac{1}{2}} {H}_{w}^{( l )} {W}_{w 1}^{( l )} )$$
wherein
$${H}_{w}^{( l + 1 )}$$
denotes the layer-to-layer propagation formula of the graph convolution network model; σ denotes a nonlinear activation function; \tilde{D}_{w} denotes a degree matrix of Ã_{w}, wherein Ã_{w}=A_{w}+E, A_{w} denotes an information matrix comprising other matrix nodes connected to a node A_{w}, E denotes an identity matrix;
$${H}_{w}^{( l )}$$
denotes a feature or an l-th layer of the graph convolution network model; and
$${W}_{w 1}^{( l )}$$
denotes a weight matrix or the l-th layer of the graph convolution network model;
the Informer model is a time sequence forecasting model based on a Transformer, comprising: a probsparse self-attention mechanism, a self-attention distilling mechanism, and parallel concurrent generation of a prediction sequence using a decoder architecture;
a formula for calculating the water requirement in a World Food study (WOFOST) physical model is embedded into a loss function of the spatiotemporal fusion model, wherein the loss function of the spatio-temporal fusion model refers to following formula:
$$LOSS = \frac{1}{m} {\sum }_{i = 1}^{m} {( {y}_{i} - {\hat{y}}_{i} )}^{2} + λ * \frac{1}{m} {\sum }_{i = 1}^{m} {( {\hat{y}}_{i} - {\hat{y}}_{wi} )}^{2}$$
wherein LOSS denotes the loss function of the spatiotemporal fusion model, m denotes a total number of samples, i denotes a sample index, yᵢ denotes an actual crop water requirement value, ŷᵢ denotes a predicted crop water requirement value, λ denotes a weight coefficient of water requirement term, and ŷ_{wi} denotes crop water requirement simulated by the WOFOST physical model.

2. The method for the large-scale prediction on the crop water requirement based on the spatiotemporal fusion model under the physical constraint according to claim 1, wherein after acquiring the multi-source data at the starting time and the multi-source data for the at least one sampling interval, the method further comprises:
inputting the multi-source data at the starting time and the multi-source data for the at least one sampling interval based on a tabular form, and performing time alignment on the multi-source data at the starting time and the multi-source data for the at least one sampling interval to obtain multi-source data with a unified format;
removing abnormal values from meteorological data in the multi-source data with the unified format based on a sliding window box plot to obtain cleaned meteorological data;
removing abnormal values from soil data in the multi-source data with the unified format based on a Mahalanobis distance to obtain cleaned soil data;
removing abnormal values from crop data in the multi-source data with the unified format based on a predetermined value range to obtain cleaned crop data;
setting the cleaned meteorological data, the cleaned soil data and the cleaned crop data as cleaned multi-source data;
performing K-nearest neighbor interpolation for missing values of the cleaned multi-source data in spatial positions, and performing linear interpolation for missing values of the cleaned multi-source data in temporal positions to obtain filled multi-source data; and
normalizing the filled multi-source data based on min-max normalization to obtain preprocessed multi-source data.

3. The method for the large-scale prediction on the crop water requirement based on the spatiotemporal fusion model under the physical constraint according to claim 1, wherein the encoding and fusing the multi-source data at the starting time and the multi-source data for the at least one sampling interval by the one-dimensional convolution and the multilayer perceptron to obtain the comprehensive feature expression comprises:
constructing a meteorological feature matrix based on meteorological features of the meteorological data, the starting time, the at least one sampling interval and a number of sampling points, wherein the meteorological features comprise air temperature, humidity, atmospheric pressure, wind speed, precipitation and sunshine duration;
performing one-dimensional convolution processing on the meteorological feature matrix to obtain an output feature map of meteorological feature data;
constructing a soil feature matrix based on soil features of the soil data, the starting time, the at least one sampling interval and the number of sampling points, wherein the soil features comprise daily mean soil temperatures at a plurality of depth positions, humidity at the plurality of depth positions and water contents at the plurality of depth positions;
performing one-dimensional convolution processing on the soil feature matrix to obtain an output feature map of soil feature data;
constructing a crop feature matrix based on crop features of the crop data, the starting time, the at least one sampling interval and the number of sampling points, wherein the crop features comprise a type of a crop, a plant height of the crop, a root depth of the crop, a leaf area index of the crop and chlorophyll content of the crop;
performing one-dimensional convolution processing on the crop feature matrix to obtain an output feature map of crop feature data; and
inputting the output feature map of the meteorological feature data, the output feature map of the soil feature data and the output feature map of the crop feature data into the multilayer perceptron to obtain the comprehensive feature expression output by the multilayer perceptron.

4. The method for the large-scale prediction on the crop water requirement based on the spatiotemporal fusion model under the physical constraint according to claim 1, wherein the inputting the comprehensive feature expression into the trained spatiotemporal feature fusion model to obtain the prediction result of crop water requirement at the target time output by the trained spatiotemporal feature fusion model comprises:
determining a target node corresponding to the meteorological data at the target time, the soil data at the target time and the crop data at the target time in the comprehensive feature expression;
performing weighted aggregation on features of neighborhood nodes of the target node through the graph convolution network model of the trained spatiotemporal feature fusion model to obtain spatial features of the target node;
determining a long time sequence of the comprehensive feature expression based on a self-attention mechanism through the Informer model of the trained spatiotemporal feature fusion model; and determining temporal features of the target node based on the long time sequence of the comprehensive feature expression; and
determining the prediction result of the crop water requirement at the target time based on the spatial features of the target node and the temporal features of the target node through the trained spatiotemporal feature fusion model.

5. The method for the large-scale prediction on the crop water requirement based on the spatiotemporal fusion model under the physical constraint according to claim 1, wherein before inputting the comprehensive feature expression into the trained spatiotemporal feature fusion model to obtain the prediction result of the crop water requirement at the target time output by the trained spatiotemporal feature fusion model, the method further comprises:
acquiring multi-source data samples, and dividing the multi-source data samples into a training sample set and a test sample set according to a predetermined proportion;
training a predetermined spatiotemporal feature fusion model based on the training sample set, and performing gradient update on the predetermined spatiotemporal feature fusion model based on an Adaptive Moment Estimation (Adam) optimizer to obtain a spatiotemporal feature fusion model after trained; and
evaluating the spatiotemporal feature fusion model after trained based on a root mean squared error, a mean absolute deviation and a determination coefficient to obtain the trained spatiotemporal feature fusion model.

6. The method for the large-scale prediction on the crop water requirement based on the spatiotemporal fusion model under the physical constraint according to claim 5, wherein the method further comprises:
inputting the training sample set into a predetermined WOFOST physical model to obtain a simulated crop water requirement output by the predetermined WOFOST physical model;
inputting the training sample set into the predetermined spatiotemporal feature fusion model to obtain a predicted crop water requirement output by the predetermined spatiotemporal feature fusion model; and
determining a loss function of the predetermined spatiotemporal feature fusion model under a constraint of the WOFOST physical model based on an actual crop water requirement in the training sample set, the simulated crop water requirement and the predicted crop water requirement.

7. A device for large-scale prediction on crop water requirement based on a spatiotemporal fusion model under a physical constraint, comprising:
an acquisition module, configured to acquire multi-source data at a starting time and multi-source data for at least one sampling interval, wherein the multi-source data at the starting time and the multi-source data for the at least one sampling interval comprise meteorological data, soil data and crop data;
a feature fusion module, configured to encode and fuse the multi-source data at the starting time and the multi-source data for the at least one sampling interval by a one-dimensional convolution and a multilayer perceptron to obtain a comprehensive feature expression, wherein the comprehensive feature expression comprises a meteorological feature at each time, a soil feature at each time and a crop feature at each time; and
a prediction module, configured to input the comprehensive feature expression into a trained spatiotemporal feature fusion model to obtain a prediction result of crop water requirement at a target time output by the trained spatiotemporal feature fusion model, wherein the trained spatiotemporal feature fusion model comprises a graph convolution network model and an Informer model; the graph convolution network model is configured to extract spatial features of the comprehensive feature expression, and the Informer model is configured to extract temporal features of the comprehensive feature expression;
wherein a layer-to-layer propagation formula of the graph convolution network model refers to the following formula:
$${H}_{w}^{( l + 1 )} = σ ( {\tilde{D}}_{w}^{- \frac{1}{2}} {\tilde{A}}_{w} {\tilde{D}}_{w}^{- \frac{1}{2}} {H}_{w}^{( l )} {W}_{w 1}^{( l )} )$$
wherein
$${H}_{w}^{( l + 1 )}$$
denotes the layer-to-layer propagation formula of the graph convolution network model; σ denotes a nonlinear activation function; \tilde{D}_{w} denotes a degree matrix of Ã_{w}, Ã_{w}=A_{w}+E, A_{w} denotes an information matrix comprising other matrix nodes connected to a node A_{w}, E denotes an identity matrix;
$${H}_{w}^{( l )}$$
denotes a feature of an l-th layer of the graph convolution network model; and
$${W}_{w 1}^{( l )}$$
denotes a weight matrix or the l-th layer of the graph convolution network model;
the Informer model is a time sequence forecasting model based on a Transformer, comprising: a probsparse self-attention mechanism, a self-attention distilling mechanism, and parallel concurrent generation of a prediction sequence using a decoder architecture;
the device for the large-scale prediction on the crop water requirement based on the spatio-temporal fusion model under the physical constraint is further configured to embed a formula for calculating the water requirement of a WOFOST physical model into a loss function of the spatiotemporal fusion model, wherein the loss function of the spatiotemporal fusion model refers to following formula:
$$LOSS = \frac{1}{m} {\sum }_{i = 1}^{m} {( {y}_{i} - {\hat{y}}_{i} )}^{2} + λ * \frac{1}{m} {\sum }_{i = 1}^{m} {( {\hat{y}}_{i} - {\hat{y}}_{wi} )}^{2}$$
wherein LOSS denotes the loss function of the spatiotemporal fusion model, m denotes a total number of samples, i denotes a sample index, yᵢ denotes an actual crop water requirement value, ŷᵢ denotes a predicted crop water requirement value, λ denotes a weight coefficient of water requirement term, and ŷ_{wi} denotes crop water requirement simulated by the WOFOST physical model.

8. An electronic device, comprising a memory, a processor and a computer program stored in the memory and executable on the processor, wherein the processor, when executing the computer program, achieves the method for the large-scale prediction on the crop water requirement based on the spatiotemporal fusion model under the physical constraint according to claim 1.

9. The electronic device according to claim 8, wherein after acquiring the multi-source data at the starting time and the multi-source data for the at least one sampling interval, the method further comprises:
inputting the multi-source data at the starting time and the multi-source data for the at least one sampling interval based on a tabular form, and performing time alignment on the multi-source data at the starting time and the multi-source data for the at least one sampling interval to obtain multi-source data with a unified format;
removing abnormal values from meteorological data in the multi-source data with the unified format based on a sliding window box plot to obtain cleaned meteorological data;
removing abnormal values from soil data in the multi-source data with the unified format based on a Mahalanobis distance to obtain cleaned soil data;
removing abnormal values from crop data in the multi-source data with the unified format based on a predetermined value range to obtain cleaned crop data;
setting the cleaned meteorological data, the cleaned soil data and the cleaned crop data as cleaned multi-source data;
performing K-nearest neighbor interpolation for missing values of the cleaned multi-source data in spatial positions, and performing linear interpolation for missing values of the cleaned multi-source data in temporal positions to obtain filled multi-source data; and
normalizing the filled multi-source data based on min-max normalization to obtain preprocessed multi-source data.

10. The electronic device according to claim 8, wherein the encoding and fusing the multi-source data at the starting time and the multi-source data for the at least one sampling interval by the one-dimensional convolution and the multilayer perceptron to obtain the comprehensive feature expression comprises:
constructing a meteorological feature matrix based on meteorological features of the meteorological data, the starting time, the at least one sampling interval and a number of sampling points, wherein the meteorological features comprise air temperature, humidity, atmospheric pressure, wind speed, precipitation and sunshine duration;
performing one-dimensional convolution processing on the meteorological feature matrix to obtain an output feature map of meteorological feature data;
constructing a soil feature matrix based on soil features of the soil data, the starting time, the at least one sampling interval and the number of sampling points, wherein the soil features comprise daily mean soil temperatures at a plurality of depth positions, humidity at the plurality of depth positions and water contents at the plurality of depth positions;
performing one-dimensional convolution processing on the soil feature matrix to obtain an output feature map of soil feature data;
constructing a crop feature matrix based on crop features of the crop data, the starting time, the at least one sampling interval and the number of sampling points, wherein the crop features comprise a type of a crop, a plant height of the crop, a root depth of the crop, a leaf area index of the crop and chlorophyll content of the crop;
performing one-dimensional convolution processing on the crop feature matrix to obtain an output feature map of crop feature data; and
inputting the output feature map of the meteorological feature data, the output feature map of the soil feature data and the output feature map of the crop feature data into the multilayer perceptron to obtain the comprehensive feature expression output by the multilayer perceptron.

11. The electronic device according to claim 8, wherein the inputting the comprehensive feature expression into the trained spatiotemporal feature fusion model to obtain the prediction result of crop water requirement at the target time output by the trained spatiotemporal feature fusion model comprises:
determining a target node corresponding to the meteorological data at the target time, the soil data at the target time and the crop data at the target time in the comprehensive feature expression;
performing weighted aggregation on features of neighborhood nodes of the target node through the graph convolution network model of the trained spatiotemporal feature fusion model to obtain spatial features of the target node;
determining a long time sequence of the comprehensive feature expression based on a self-attention mechanism through the Informer model of the trained spatiotemporal feature fusion model; and determining temporal features of the target node based on the long time sequence of the comprehensive feature expression; and
determining the prediction result of the crop water requirement at the target time based on the spatial features of the target node and the temporal features of the target node through the trained spatiotemporal feature fusion model.

12. The electronic device according to claim 8, wherein before inputting the comprehensive feature expression into the trained spatiotemporal feature fusion model to obtain the prediction result of the crop water requirement at the target time output by the trained spatiotemporal feature fusion model, the method further comprises:
acquiring multi-source data samples, and dividing the multi-source data samples into a training sample set and a test sample set according to a predetermined proportion;
training a predetermined spatiotemporal feature fusion model based on the training sample set, and performing gradient update on the predetermined spatiotemporal feature fusion model based on an Adam optimizer to obtain a spatiotemporal feature fusion model after trained; and
evaluating the spatiotemporal feature fusion model after trained based on a root mean squared error, a mean absolute deviation and a determination coefficient to obtain the trained spatiotemporal feature fusion model.

13. The electronic device according to claim 12, wherein the method further comprises:
inputting the training sample set into a predetermined WOFOST physical model to obtain a simulated crop water requirement output by the predetermined WOFOST physical model;
inputting the training sample set into the predetermined spatiotemporal feature fusion model to obtain a predicted crop water requirement output by the predetermined spatiotemporal feature fusion model; and
determining a loss function of the predetermined spatiotemporal feature fusion model under a constraint of the WOFOST physical model based on an actual crop water requirement in the training sample set, the simulated crop water requirement and the predicted crop water requirement.

14. A non-transitory computer-readable storage medium, wherein a computer program is stored on the non-transitory computer-readable storage medium, and wherein the computer program, when executed by a processor, achieves the method for the large-scale prediction on the crop water requirement based on the spatiotemporal fusion model under the physical constraint according to claim 1.

15. The non-transitory computer-readable storage medium according to claim 14, wherein after acquiring the multi-source data at the starting time and the multi-source data for the at least one sampling interval, the method further comprises:
inputting the multi-source data at the starting time and the multi-source data for the at least one sampling interval based on a tabular form, and performing time alignment on the multi-source data at the starting time and the multi-source data for the at least one sampling interval to obtain multi-source data with a unified format;
removing abnormal values from meteorological data in the multi-source data with the unified format based on a sliding window box plot to obtain cleaned meteorological data;
removing abnormal values from soil data in the multi-source data with the unified format based on a Mahalanobis distance to obtain cleaned soil data;
removing abnormal values from crop data in the multi-source data with the unified format based on a predetermined value range to obtain cleaned crop data;
setting the cleaned meteorological data, the cleaned soil data and the cleaned crop data as cleaned multi-source data;
performing K-nearest neighbor interpolation for missing values of the cleaned multi-source data in spatial positions, and performing linear interpolation for missing values of the cleaned multi-source data in temporal positions to obtain filled multi-source data; and
normalizing the filled multi-source data based on min-max normalization to obtain preprocessed multi-source data.

16. The non-transitory computer-readable storage medium according to claim 14, wherein the encoding and fusing the multi-source data at the starting time and the multi-source data for the at least one sampling interval by the one-dimensional convolution and the multilayer perceptron to obtain the comprehensive feature expression comprises:
constructing a meteorological feature matrix based on meteorological features of the meteorological data, the starting time, the at least one sampling interval and a number of sampling points, wherein the meteorological features comprise air temperature, humidity, atmospheric pressure, wind speed, precipitation and sunshine duration;
performing one-dimensional convolution processing on the meteorological feature matrix to obtain an output feature map of meteorological feature data;
constructing a soil feature matrix based on soil features of the soil data, the starting time, the at least one sampling interval and the number of sampling points, wherein the soil features comprise daily mean soil temperatures at a plurality of depth positions, humidity at the plurality of depth positions and water contents at the plurality of depth positions;
performing one-dimensional convolution processing on the soil feature matrix to obtain an output feature map of soil feature data;
constructing a crop feature matrix based on crop features of the crop data, the starting time, the at least one sampling interval and the number of sampling points, wherein the crop features comprise a type of a crop, a plant height of the crop, a root depth of the crop, a leaf area index of the crop and chlorophyll content of the crop;
performing one-dimensional convolution processing on the crop feature matrix to obtain an output feature map of crop feature data; and
inputting the output feature map of the meteorological feature data, the output feature map of the soil feature data and the output feature map of the crop feature data into the multilayer perceptron to obtain the comprehensive feature expression output by the multilayer perceptron.

17. The non-transitory computer-readable storage medium according to claim 14, wherein the inputting the comprehensive feature expression into the trained spatiotemporal feature fusion model to obtain the prediction result of crop water requirement at the target time output by the trained spatiotemporal feature fusion model comprises:
determining a target node corresponding to the meteorological data at the target time, the soil data at the target time and the crop data at the target time in the comprehensive feature expression;
performing weighted aggregation on features of neighborhood nodes of the target node through the graph convolution network model of the trained spatiotemporal feature fusion model to obtain spatial features of the target node;
determining a long time sequence of the comprehensive feature expression based on a self-attention mechanism through the Informer model of the trained spatiotemporal feature fusion model; and determining temporal features of the target node based on the long time sequence of the comprehensive feature expression; and
determining the prediction result of the crop water requirement at the target time based on the spatial features of the target node and the temporal features of the target node through the trained spatiotemporal feature fusion model.

18. The non-transitory computer-readable storage medium according to claim 14, wherein before inputting the comprehensive feature expression into the trained spatiotemporal feature fusion model to obtain the prediction result of the crop water requirement at the target time output by the trained spatiotemporal feature fusion model, the method further comprises:
acquiring multi-source data samples, and dividing the multi-source data samples into a training sample set and a test sample set according to a predetermined proportion;
training a predetermined spatiotemporal feature fusion model based on the training sample set, and performing gradient update on the predetermined spatiotemporal feature fusion model based on an Adam optimizer to obtain a spatiotemporal feature fusion model after trained; and
evaluating the spatiotemporal feature fusion model after trained based on a root mean squared error, a mean absolute deviation and a determination coefficient to obtain the trained spatiotemporal feature fusion model.

19. The non-transitory computer-readable storage medium according to claim 18, wherein the method further comprises:
inputting the training sample set into a predetermined WOFOST physical model to obtain a simulated crop water requirement output by the predetermined WOFOST physical model;
inputting the training sample set into the predetermined spatiotemporal feature fusion model to obtain a predicted crop water requirement output by the predetermined spatiotemporal feature fusion model; and
determining a loss function of the predetermined spatiotemporal feature fusion model under a constraint of the WOFOST physical model based on an actual crop water requirement in the training sample set, the simulated crop water requirement and the predicted crop water requirement.
